(19) United States
(12) Patent Application Publication
(10) Pub. No.: US 2022/0036448 A1
(43) Pub. Date: Feb. 3, 2022

(54) Electronic Commerce Service Device and Operating Method Therefor, and Service Device

(71) Applicant: SK Planet Co., Ltd., Seongnam-si (KR)

(72) Inventor: Ki Chon KANG, Seoul (KR)

(21) Appl. No.: 17/503,780

(22) Filed: Oct. 18, 2021

Related U.S. Application Data
(63) Continuation of application No. PCT/KR2020/006427, filed on May 15, 2020.

(30) Foreign Application Priority Data
May 15, 2019 (KR) 10-2019-0057156
Jun. 4, 2019 (KR) 10-2019-0066153

(51) Int. Cl. G06Q 30/08; G06Q 30/06

(52) U.S. Cl. CPC G06Q 30/08; G06Q 30/0635

(57) ABSTRACT

The present invention relates to an electronic commerce service device and an operating method therefor, which process product delivery between a supplier and a purchaser by selecting, through competitive bidding, the supplier of a product requested for purchase by the purchaser in a blockchain network environment. In addition, the present invention relates to a service device capable of storing, in a blockchain network, customer data related to member store service use and limiting, according to customer settings, access to the customer data stored in the blockchain network.

### CROSS-REFERENCE TO RELATED APPLICATIONS

This application is a bypass continuation application of International PCT Application No. PCT/KR2020/006427 filed on May 15, 2020, which claims priority to Republic of Korea Patent Application No. 10-2019-0057156 filed on May 15, 2019 and Republic of Korea Patent Application No. 10-2019-0066153 filed on Jun. 4, 2019, which are incorporated by reference herein their entirety.

### BACKGROUND

The present disclosure relates to a method for processing product delivery between a supplier and a purchaser by selecting, via competitive bidding, the supplier of a product requested for purchase by the purchaser in a blockchain network environment.

In addition, the present disclosure relates to a technology for storing, in a blockchain network, customer data related to usage of member store service and restricting, according to customer settings, access to the customer data stored in the blockchain network.

Bitcoin was created based on Satoshi Nakamoto's thesis in 2000, and Bitcoin having a decentralized and autonomous ecosystem has been used for more than 10 years.

The core of the Bitcoin-based technology corresponds to a method of generating a distributed ledger that cannot be manipulated via a P2P network. An autonomous system of Bitcoin, for which external manipulation is impossible, may supply, for system stability, cryptocurrency in exchange for mining according to a scheme of solving mathematical problems at a certain time, which is referred to as Proof of Working.

This has proved the possibility of a cryptocurrency system and has provided a clue for supplying distributed ledgers and cryptocurrency, but merely corresponds to a primitive form in relation to issues of applying distributed ledgers to various fields.

Accordingly, Ethereum announced by Vitalic Buterin in 2014 has provided scalability of applying Ethereum in various fields on the basis of a smart contract.

That is, a standard technology, such as decentralized application (Dapp), may be provided which enables integration into an Ethereum cryptocurrency system even if a new cryptocurrency is created in any application field.

In other words, Ethereum becomes a base technology for various applications running on a blockchain via a role of an operating system such as the Android OS for smartphones for example, just as the Android OS becomes the basis for mobile applications in smartphones, which are used by users.

Here, all applications implemented on a blockchain are referred to as decentralized applications, that is, Dapps, and it is thus possible to apply the blockchain technology to various application service fields via Dapps and smart contracts in the Ethereum environment.

Accordingly, in the present disclosure, it is intended to implement an electronic commerce service and a member store service, which is one of application service fields, for purchase and delivery of products, on the basis of the scalability of Ethereum.

### SUMMARY OF DISCLOSURE

The present disclosure is provided in consideration of the above circumstances, and an aspect of the present disclosure is to process product delivery between a supplier and a purchaser by selecting, via competitive bidding, the supplier of a product requested for purchase by the purchaser in a blockchain network environment.

In addition, the present disclosure is provided in consideration of the above circumstances, and an aspect of the present disclosure is to store customer data related to use of a member store service in a blockchain network, and to limit access to the stored customer data according to customer settings.

An electronic commerce service device according to a first embodiment of the present disclosure to achieve the aspect includes: a processor configured to process a calculation related to a blockchain network; and a memory configured to store at least one command executed via the processor, wherein the at least one command includes: a bid command for selection of a supplier of a specific product received from a purchaser, via competitive bidding for a supply price, in response to a purchase request for the specific product; and a generation command for causing generation of a transaction related to the competitive budding so as to cause a bid information blockchain to be generated in the blockchain network.

Specifically, the at least one command may further include a delivery command for approval of a delivery request made by a distributor having identified delivery information from the bid information blockchain, and tracking of a delivery state of the specific product.

Specifically, the generation command may cause generation of a transaction related to delivery of the specific product so as to cause generation of a service completion blockchain in which a transaction block is added to the bid information blockchain.

Specifically, in the service completion blockchain, evaluation information obtained by evaluation of a purchaser with respect to at least one of the supplier and the distributor is recorded as a transaction block, and the evaluation information may be used as information for restricting the supplier's participation in competitive bidding or restricting the distributor's request for delivery.

Specifically, the bid command may cause a supply price, which is proposed by a bidder with respect to each product, to be pre-registered and updated as bid application information, and when a purchase request for the specific product is made, the bid command may cause competitive bidding to be conducted by selection of bid application information matching the specific product.

Specifically, when the remaining time until the end of the competitive bidding is less than a threshold time, and the number of bidders participating in the competitive bidding is less than the threshold number, the bid command causes competitive bidding for the remaining time to be conducted by selection of the pre-registered bid application information.

Specifically, according to a delivery request area designated on the basis of a location of at least one of the purchaser and the supplier, the delivery information may be recorded, in the bid information blockchain, as a transaction block matching electronic wallet address information of the distributor having configured the delivery request area as a delivery available area, and when there are multiple bid information blockchains generated in the blockchain network, the distributor may collectively identify delivery information matching the electronic wallet address information from the multiple bid information blockchains.

Specifically, the at least one command may further include a generation command for generation of a smart contract for distribution to the blockchain network, so as to cause at least one of the competitive bidding and delivery of the specific product to be processed according to the smart contract.

An operation method of an electronic commerce service device according to the first embodiment of the present disclosure to achieve the aspect includes: a bidding operation of selecting a supplier of a specific product received from a purchaser, via competitive bidding for a supply price, in response to a purchase request for the specific product; and a generation operation of causing generation of a transaction related to the competitive budding so as to cause a bid information blockchain to be generated in the blockchain network.

Specifically, the method may further include a delivery operation of approving a delivery request made by a distributor having identified delivery information from the bid information blockchain, and tracking a delivery state of the specific product.

Specifically, the method may further include a generation operation of, when delivery of the specific product is processed, causing generation of a transaction related to the delivery of the specific product, so as to cause generation of a service completion blockchain in which a transaction block is added to the bid information blockchain.

Specifically, in the service completion blockchain, evaluation information obtained by evaluation of a purchaser with respect to at least one of the supplier and the distributor is recorded as a transaction block, and the evaluation information may be used as information for restricting the supplier's participation in competitive bidding or restricting the distributor's request for delivery.

A service device according to a second embodiment of the present disclosure to achieve the aspect includes: a processor configured to process operations related to a blockchain network; and a memory configured to store at least one command executed via the processor, wherein the at least one command includes: a determination command for determination of whether an information collection medium satisfies an information collection condition, in response to a request for collecting information on a specific customer, which is received from the information collection medium; and a transfer command for, when the information collection condition is satisfied, causing transferring of at least a part of the entire customer data of the specific customer, which is stored as a transaction block in the blockchain network, to the information collection medium according to an information permission policy.

Specifically, the at least one command may further include a reward command for, when the customer data has been transferred to the information collection medium, causing electronic money, which is issued in the blockchain network, to be transferred to the specific customer according to an information reward policy.

Specifically, at least one of the information collection condition, the information permission policy, and the information reward policy may be generated as a smart contract for the specific customer so as to be stored in the blockchain network, and the smart contract may be generated on the basis of access configuration information that is input from the specific customer according to a membership subscription procedure of a member store.

Specifically, the customer data may be classified as two or more pieces of service identification information according to a type of a service provided by a member store, and when the specific customer uses two or more services, the customer data may be generated as an individual transaction block matching each piece of service identification information, or may be integrated into a single transaction block so as to be stored in the blockchain network.

Specifically, when the customer data is generated as an individual transaction block matching each piece of service identification information, the transfer command may cause identification of specific service identification information, for which information collection is permitted, according to the information permission policy, and may cause customer data to be acquired from a transaction block matching the specific service identification information from among transaction blocks stored in the blockchain network.

Specifically, when the customer data is integrated into a single transaction block irrelevant to the service identification information, the transfer command may: if the customer data is integrated into a single transaction block irrelevant to service identification information, cause generation of an information transfer filter to transfer customer data of specific service identification information, from which information collection is permitted, according to the information permission policy; and cause only the customer data of the specific service identification information to be transferred to the information collection medium by applying the information transfer filter to the entire customer data acquired from the transaction block of the blockchain network.

Specifically, the information transfer filter may be information for encryption of customer data of service identification information remaining after excluding the customer data corresponding to the specific service identification information from the entire customer data acquired from the transaction block of the blockchain network.

Specifically, electronic money to be transferred to the specific customer may be at least a part of the amount of electronic money that the information collection medium pays for information collection according to the information collection condition.

According to an electronic commerce service device and an operation method thereof in accordance with a first embodiment of the present disclosure, the stability and satisfaction in an electronic commerce service for product purchase and delivery can be improved by selecting, via competitive bidding, a supplier of a product requested for purchase by a purchaser, so as to process product delivery between the supplier and the purchaser in a blockchain network environment.

According to a service device in accordance with a second embodiment of the present disclosure, customer data related to use of a service of a member store is stored in a blockchain network, and collection (viewing) of the customer data stored in the blockchain network can be restricted on the basis of customer settings, so that stable use of the customer data is possible on the basis of the stability and reliability of the blockchain technology and an intention of a customer.

### BRIEF DESCRIPTION OF THE DRAWINGS

FIG. 1 is a schematic configuration diagram of an electronic commerce service system according to a first embodiment of the present disclosure;

FIG. 2 is a schematic configuration diagram of a purchaser terminal according to the first embodiment of the present disclosure;

FIG. 3 is an exemplary diagram of a hardware system for implementing a purchaser terminal according to the first embodiment of the present disclosure;

FIG. 4 is a schematic configuration diagram of an electronic commerce service device according to the first embodiment of the present disclosure;

FIG. 5 is an exemplary diagram of a hardware system for implementing an electronic commerce service device according to the first embodiment of the present disclosure;

FIG. 6 is a schematic flowchart for explaining an operation flow in an electronic commerce service system according to the first embodiment of the present disclosure;

FIG. 7 is a schematic flowchart for explaining an operation flow in a purchaser terminal according to the first embodiment of the present disclosure;

FIG. 8 is a schematic flowchart for explaining an operation flow in an electronic commerce service device according to the first embodiment of the present disclosure;

FIG. 9 is a schematic configuration diagram of a member store service system according to a second embodiment of the present disclosure;

FIG. 10 is a schematic configuration diagram of a customer device according to the second embodiment of the present disclosure;

FIG. 11 is an exemplary diagram of a hardware system for implementing a customer device according to the second embodiment of the present disclosure;

FIG. 12 is a schematic configuration diagram of a member store device according to the second embodiment of the present disclosure;

FIG. 13 is an exemplary diagram of a hardware system for implementing a member store device according to the second embodiment of the present disclosure;

FIG. 14 is a schematic flowchart for explaining an operation flow in a member store service device according to the second embodiment of the present disclosure;

FIG. 15 is a schematic flowchart for explaining an operation flow in a customer device according to the second embodiment of the present disclosure; and

FIG. 16 is a schematic flowchart for explaining an operation flow in a member store device according to the second embodiment of the present disclosure.

### DETAILED DESCRIPTION

It should be noted that the technical terms as used herein are merely used for describing particular embodiments, and are not intended to limit the scope of the present disclosure. Further, the technical terms in the specification should be construed as a meaning generally understood by those skilled in the art unless the terms are defined as another meaning and should not be construed as an excessively inclusive meaning or an excessively exclusive meaning. When a technical term used in the specification is an incorrect technical term which does not accurately express the idea of the present disclosure, the technical term should be replaced with the correct technical term which can be understood by those skilled in the art. Further, the general terms used in the present disclosure should be interpreted in the context according to the dictionary definition and should not be construed as possessing an excessively limited meaning.

In addition, a singular expression used in the specification includes a plural expression as long as they are clearly distinguished in the context. In the specification, the term “comprise” or “include” should not be construed as necessarily including all of various elements or various steps disclosed herein, and it should be understood that some of the elements or steps may not be included, or additional elements or steps may be further included.

In addition, although terms including ordinal numbers such as first, second, and the like may be used to describe various elements, the elements should not be restricted by the terms. The terms are used merely for the purpose to distinguish an element from the other elements. For example, a first element may be termed a second element, and similarly, a second element may be termed a first element without departing from the scope of the present disclosure.

Hereinafter, embodiments of the present disclosure will be described in detail with reference to the accompanying drawings, equal or similar elements are assigned an equal reference numeral, and an overlapping description thereof will be omitted.

Further, in the following description of the technology of the present disclosure, a detailed description of known technologies incorporated herein will be omitted when it may make the subject matter of the present disclosure rather unclear. Further, it should be noted that the accompanying drawings are intended only for the easy understanding of the technical idea of the present disclosure, and the technical idea should not be construed as being limited by the accompanying drawings.

Hereinafter, a first embodiment of the present disclosure will be described with reference to the accompanying drawings.

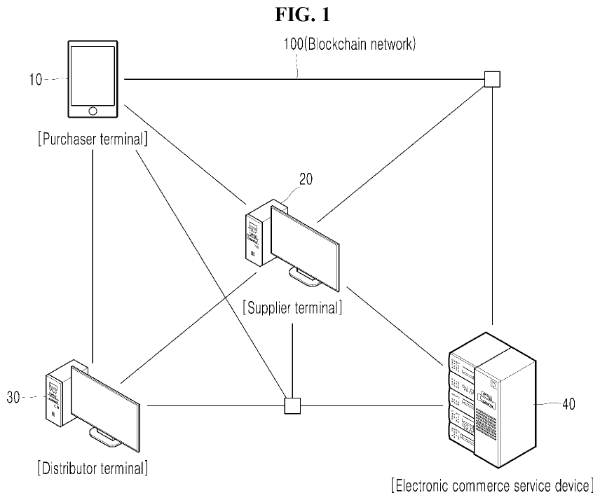

FIG. 1 is a diagram illustrating an electronic commerce service system according to the first embodiment of the present disclosure.

As illustrated in FIG. 1, an electronic commerce service system according to the first embodiment of the present disclosure may include: a purchaser terminal 10 configured to transfer a product purchase request of a purchaser; a supplier terminal 20 corresponding to a supplier that supplies a product; a distributor terminal 30 that is a distributor delivering a product; and an electronic commerce service device 40 configured to provide an electronic commerce service for product purchase and delivery.

Respective elements included in the electronic commerce service system may correspond to respective nodes constituting a blockchain network 100, and the elements may be implemented in various forms including, for example, a mobile terminal such as a smartphone, a computer such as a PC, a wired or wireless mobile or fixed controller having a user interface, a server, or the like.

For reference, in a case where respective nodes in the blockchain network are implemented in the form of servers, the nodes may be implemented in the form of, for example, a web server, a database server, a proxy server, and the like, and one or more pieces of various software may be installed, via which a computerized system may also be implemented, wherein the various software enables a network load balancing mechanism and operation of a service device on the Internet or other networks.

The network may be an http network and may be a private line, an intranet, or any other network. Connections between respective elements within a blockchain network system according to the first embodiment of the present disclosure may be established via a security network so as to prevent data from being attacked by any hacker or other third party.

In this blockchain network, continuously increasing data is recorded in a specific unit of block, and respective participant nodes constituting a peer-to-peer (P2P) network may manage corresponding blocks in a chain-type data structure.

Blockchain data configured by the chain-type data structure is operated in the form of a distributed ledger at each node without a central system.

In respective nodes constituting the blockchain network, blocks are managed in a chain form on the basis of a data structure of recording a hash value of a previous block in a current block, and the previous block may be thus referred via the hash value.

Therefore, as more blocks managed in the chain form in respective nodes are accumulated, forgery and alteration of transaction data recorded in the block becomes difficult, and the reliability of transaction data recorded in respective blocks may be improved.

In particular, a blockchain network 200 according to the first embodiment of the present disclosure follows, for example, an Ethereum environment which enables the blockchain technology to be applied to various application service fields on the basis of a smart contract.

Here, Ethereum provides a standard technology, such as decentralized application (Dapp), which enables integration into an Ethereum cryptocurrency system even if a new cryptocurrency is created in any application field.

In other words, Ethereum becomes, for example, via a role of an operating system such as the Android OS for smartphones, a base technology for various applications running on a blockchain, just as the Android OS becomes the basis for mobile applications in smartphones, which are used by users.

Here, all applications implemented on a blockchain are referred to as decentralized applications, that is, Dapps, and it is thus possible to apply the blockchain technology to various application service fields via Dapps and smart contracts in the Ethereum environment.

Accordingly, in the first embodiment of the present disclosure, the blockchain technology is applied to electronic commerce service fields on the basis of the scalability of Ethereum.

Specifically, a supplier that supplies a product requested for purchase by a purchaser is selected via competitive bidding on the basis of the blockchain network 100, and product delivery is processed via a scheme of approving a delivery request from a distributor having confirmed delivery information between the purchaser and the supplier. Hereinafter, configurations of the purchaser terminal 10 and the electronic commerce service device 40 for realizing the described selection and product delivery will be described in more detail.

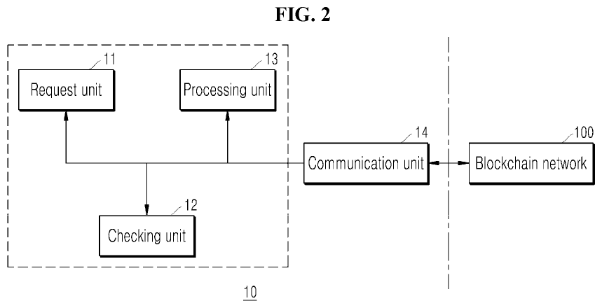

FIG. 2 shows a configuration of the purchaser terminal 10 according to the first embodiment of the present disclosure.

As illustrated in FIG. 2, the purchaser terminal 10 according to the first embodiment of the present disclosure may include a request unit 11 configured to request product purchase, a checking unit 12 configured to check the progress of competitive bidding according to a product purchase request, and a processing unit 13 configured to process a product purchase procedure with a supplier selected via competitive bidding.

All or at least some elements of the purchaser terminal 10 including the request unit 11, the checking unit 12, and the processing unit 13 may be implemented in the form of a software module or a hardware module executed by a processor or may also be implemented in the form of a combination of a software module and a hardware module.

In particular, these elements are for using an electronic commerce service based on the blockchain network 100, and may be subjects that maintain and manage blockchain data on the basis of a blockchain algorithm, which can be implemented in the form of a decentralized application, that is, a decentralized application (Dapp).

In addition to the aforementioned elements, the purchaser terminal 10 according to the first embodiment of the present disclosure may further include a communication unit 14 that is an RF module for practical communication with the blockchain network 100.

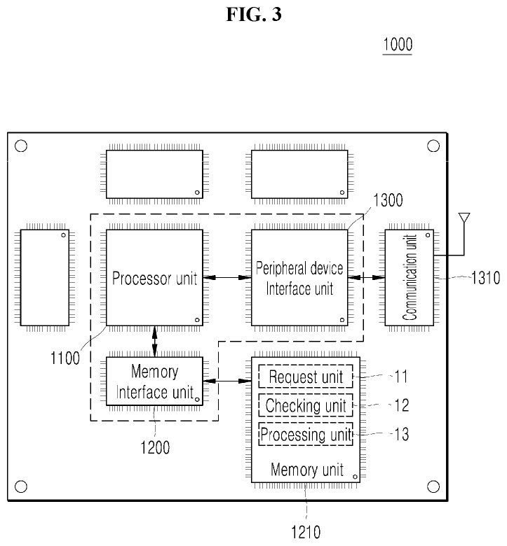

For reference, a configuration of the communication unit 13 corresponds to the communication unit 1310 to be described with reference to FIG. 3, and therefore a detailed description will be provided below.

The purchaser terminal 10 according to the first embodiment of the present disclosure may use an electronic commerce service relating to product purchase and delivery via the aforementioned elements, and each element within the purchaser terminal 10 for realizing this will be described in more detail in the following.

The request unit 11 performs a function of requesting a product purchase.

More specifically, the request unit 11 transfers a purchase request for a specific product to the electronic commerce service device 40.

In this regard, when a purchase request for a specific product is received from the purchaser terminal 10, the electronic commerce service device 40 may generate a smart contract for the purchase request and distribute the same to blockchain network 100, so as to enable competitive bidding and delivery to be processed according to the distributed smart contract.

The requesting unit 11 may configure, for example, additional information, such as specific details (e.g., 1000 ml of milk) of a specific product desired to be purchased, a bidding scheme, such as general competitive bidding, limited competitive bidding, and nominated competitive bidding, a delivery address, and a delivery fee payment method, and this configuration information is reflected in the smart contract generated by the electronic commerce service device 40.

The checking unit 12 performs a function of checking the progress of competitive bidding.

More specifically, the checking unit 12 allows a purchaser to check the progress of a competitive bidding procedure in the electronic commerce service device 40 in response to a purchase request for a specific product.

In this regard, in response to a purchase request for a specific product received from the purchaser terminal 10, the electronic commerce service device 40 proceeds with competitive bidding for a supply price of the product, and selects a bidder having proposed the most reasonable supply price, as a supplier of the specific product that the purchaser terminal 10 has requested to purchase.

Here, the competitive bidding is based on real-time participation of a bidder, but it is also possible to proceed with the competitive bidding by selecting pre-registered bidding application information, as an exception.

For example, if the remaining time until the end of the competitive bidding is less than a threshold time, and the number of bidders participating in the competitive bidding is less than a threshold number, the competitive bidding for the remaining time may be proceeded with by selecting the pre-registered bid application information.

If the time, at which a purchase request is received from the purchaser terminal 10, is early morning. etc., and it is thus difficult for a bidder to participate in bidding in real time, it is also possible to proceed with competitive bidding by selecting pre-registered bid application information regardless of the remaining time until the end of the competitive bidding.

To this end, the electronic commerce service device 40 pre-registers, as bidding application information, a supply price suggested by a bidder for each product, and updates and manages the same in each period (e.g., one week, 24 hours, etc.), and therefore when a purchase request for a specific product is requested, competitive bidding may be carried out by selecting bid application information that matches the product.

In a procedure of the competitive bidding, the electronic commerce service device 40 enables a bidding information blockchain to be generated in the blockchain network 100 by generation of a transaction related to the competitive bidding, and accordingly all information on the competitive bidding or information limited according to a configuration is stored in the blockchain network 100.

The processing unit 13 processes a product purchase procedure.

More specifically, when a supplier has been selected via competitive bidding, the processing unit 13 performs a follow-up procedure for product purchase, such as payment of a purchase price, so as to enable product delivery to be processed.

Here, due to the nature of the blockchain network 10, it is possible to process payment of the purchase price via a scheme of remitting (transferring) electronic money issued from the blockchain network 10 between a purchaser and a supplier.

In this regard, after selection of the supplier, when it is determined that the follow-up procedure for product purchase has been completed, the electronic commerce service device 40 processes the product delivery.

When a delivery request is received from a distributor having confirmed delivery information from the bidding information blockchain of the blockchain network 10, the electronic commerce service device 40 allows, by approving the delivery request, delivery to be proceeded via the distributor, and tracks a delivery state of the product until the delivery of the product is completed.

Only a distributor, who has configured, as a delivery available area, a delivery request area designated on the basis of a location of at least one of the purchaser and the supplier, may confirm the delivery information.

That is, the delivery information is recorded as a transaction block in the bidding information blockchain when the competitive bidding is completed, wherein the transaction block matches electronic wallet address information of the distributor who has configured a corresponding area as the delivery available area according to the delivery request area designated on the basis of the location of at least one of the purchaser and the supplier.

The distributor may confirm delivery information matching his/her own electronic wallet address information from the blockchain network 100, and if multiple bidding information blockchains have been generated in the blockchain network 100, the distributor may collectively confirm the delivery information matching his/her own electronic wallet address information.

By generating a transaction related to delivery in this delivery procedure, the electronic commerce service device 40 causes generation of a service completion blockchain in which the transaction block is added to the bidding information blockchain, and accordingly all information relating to the delivery or information limited according to the configuration may be recorded and stored in the blockchain network 100.

For reference, in the service completion blockchain, evaluation information obtained by evaluation of the purchaser with respect to at least one of the supplier and the distributor may be recorded as a transaction block, and the evaluation information may be used as, for example, information for restricting the supplier's participation in competitive bidding or restricting the distributor's request for delivery.

It has been mentioned that each element in the purchaser terminal 10 described above may be implemented in the form of a software module or a hardware module executed by the processor, or may be implemented in the form of a combination of a software module and a hardware module.

A software module, a hardware module, or a combination of a software module and a hardware module executed by the processor may be implemented as an actual hardware system (e.g., a computer system).

Accordingly, hereinafter, a description will be given of a hardware system 1000, in which the purchaser terminal 10 according to the first embodiment of the present disclosure is implemented in a hardware form, with reference to FIG. 3.

For reference, the contents to be described below is an example of implementing, as the hardware system 1000, each element within the aforementioned purchaser terminal 10, and it should be kept in mind that each element and a resulting operation thereof may differ from an actual system.

As illustrated in FIG. 3, the hardware system 1000 according to the first embodiment of the present disclosure may include a processor unit 1100, a memory interface unit 1200, and a peripheral device interface unit 1300.

Each element in the hardware system 1000 may be an individual part or may be integrated into one or more integrated circuits, and each of these elements may be combined by a bus system (not illustrated).

The bus system is abstraction representing multi-drop or point-to-point connections, communication lines/interfaces, and/or any one or more individual physical buses connected by appropriate bridges, adapters, and/or controllers.

The processor unit 1100 executes various software modules stored in a memory unit 1210, by communicating with the memory unit 1210 via the memory interface unit 1200 in order to perform various functions in the hardware system.

Here, in the memory unit 1210, the request unit 11, the checking unit 12, and the processing unit 12 which are elements of the purchaser terminal 10 described with reference to FIG. 2 may be stored in the form of software modules, and an operating system (OS) may be additionally stored.

The operating system (e.g., iOS, Android, Darwin, RTXC, LINUX, UNIX, OS X, WINDOWS, or embedded operating system such as VxWorks) includes various procedures, instruction sets, software components and/or drivers which control and manage common system operations(for example, memory management, storage device control, power management, etc.), and serves to facilitate communication between various hardware modules and software modules.

For reference, the memory unit 1210 includes a cache, a main memory, and a secondary memory, but may include a memory hierarchy that is not limited thereto, wherein the memory hierarchy is implemented via, for example, any combination of RAM (e.g., SRAM, DRAM, or DDRAM), ROM, FLASH, magnetic, and/or an optical storage device [e.g., disk drive, magnetic tape, compact disk (CD), digital video disk (DVD), etc.].

The peripheral device interface unit 1300 serves to enable communication between the processor unit 1100 and a peripheral device.

The peripheral device is for providing different functions to the hardware system 1000, and in the first embodiment of the present disclosure, for example, the communication unit 1310 may be included.

The communication unit 1310 serves to provide a communication function with another device, and to this end, the communication unit 1310 includes, for example, an antenna system, an RF transceiver, one or more amplifiers, a tuner, one or more oscillators, a digital signal processor, a codec chipset, a memory, etc., but is not limited thereto. Further, the communication unit 1310 may include a known circuit that performs this function.

Communication protocols supported by the communication unit 1310 may include, for example, wireless LAN (WLAN), digital living network alliance (DLNA), wireless broadband (Wibro), world interoperability for microwave access (Wimax), global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), IEEE 802.16, long term evolution (LTE), long term evolution-advanced (LTE-A), wireless mobile broadband service (WMBS), Bluetooth, radio frequency identification (RFID), infrared communication (infrared data association: IrDA), ultra-wideband (UWB), ZigBee, near field communication (NFC), ultra sound communication (USC), visible light communication (VLC), Wi-Fi, Wi-Fi Direct, and the like. A wired communication network may include wired local area network (LAN), wired wide area network (WAN), power line communication (PLC), USB communication, Ethernet, serial communication, optical/coaxial cable, and the like, but may not be limited thereto. Further, any protocol capable of providing an environment of communication with other devices may be included.

Each element within the purchaser terminal 10, which is stored in the form of software module in the memory unit 1210 in the hardware system 1000 according to the first embodiment of the present disclosure may perform, on the basis of instructions executed by the processor unit 1100, interface with the communication unit 1310 via the memory interface unit 1200 and the peripheral device interface unit 1300, thereby enabling use of an electronic commerce service relating to product purchase and delivery.

The description of the configuration of the purchaser terminal 10 according to the first embodiment of the present disclosure has been finished, and the description of the configuration of the electronic commerce service device 20 will be continued.

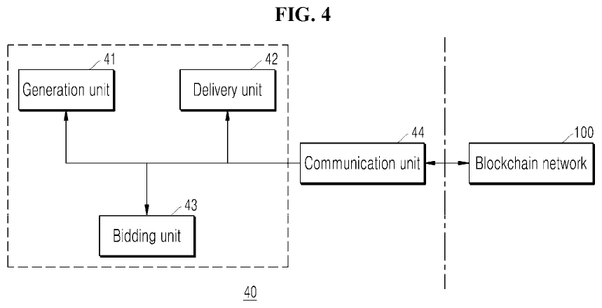

FIG. 4 shows a schematic configuration of the electronic commerce service device 40 according to according to the first embodiment of the present disclosure.

As illustrated in FIG. 4, the electronic commerce service device 40 according to the first embodiment of the present disclosure may include a generation unit 41, a bidding unit 42 configured to process competitive bidding, and a delivery unit 43 configured to process delivery.

All or at least some elements of the electronic commerce service device 40 including the generation unit 41, the bidding unit 42, and the delivery unit 43 may be implemented in the form of a software module or a hardware module executed by the processor or may also be implemented in the form of a combination of a software module and a hardware module.

In particular, these elements are for processing an electronic commerce service via association with the blockchain network 100, and may be subjects that maintain and manage blockchain data on the basis of a blockchain algorithm, which can be implemented in the form of a decentralized application, that is, a decentralized application (Dapp).

In addition to the aforementioned elements, the electronic commerce service device 40 according to the first embodiment of the present disclosure may further include a communication unit 44 that is an RF module for practical communication with the blockchain network 100.

For reference, a configuration of the communication unit 44 corresponds to the communication unit 4310 to be described with reference to FIG. 3, and therefore a detailed description will be provided below.

The electronic commerce service device 40 according to the first embodiment of the present disclosure may provide a competitive bidding-based electronic commerce service via the aforementioned elements, and each element within the electronic commerce service device 40 for realizing this will be described in more detail in the following.

The generation unit 41 generates a smart contract.

More specifically, when a purchase request for a specific product is received from the purchaser terminal 10, the generation unit 41 may generate a smart contract for the purchase request and distribute the same to blockchain network 100, so as to enable competitive bidding and delivery to be processed according to the distributed smart contract.

The purchaser terminal 10 may configure, for example, additional information, such as specific details (e.g., 1000 ml of milk) of a specific product desired to be purchased, a bidding scheme, such as general competitive bidding, limited competitive bidding, and nominated competitive bidding, a delivery address, and a delivery fee payment method, and this configuration information may be reflected in the smart contract generated for competitive bidding and delivery processing.

The bidding unit 42 proceeds with competitive bidding.

More specifically, when a smart contract for a purchase request for a specific product received from the purchaser terminal 10 is generated, the bidding unit 42 proceeds with competitive bidding according to contents of the smart contract.

The bidding unit 42 selects a bidder, who has proposed the most reasonable supply price for the specific product requested by a purchaser, as a supplier of the specific product requested by the purchaser terminal 10 from among bidders participating in the competitive bidding.

Here, the competitive bidding is based on real-time participation of a bidder, but it is also possible to proceed with the competitive bidding by selecting pre-registered bidding application information, as an exception.

For example, if the remaining time until the end of the competitive bidding is less than a threshold time, and the number of bidders participating in the competitive bidding is less than a threshold number, the competitive bidding for the remaining time may be proceeded with by selecting the pre-registered bid application information.

If the time, at which a purchase request is received from the purchaser terminal 10, is early morning. etc., and it is thus difficult for a bidder to participate in bidding in real time, it is also possible to proceed with competitive bidding by selecting pre-registered bid application information regardless of the remaining time until the end of the competitive bidding.

To this end, the bidding unit 42 pre-registers, as bidding application information, a supply price suggested by a bidder for each product, and updates and manages the same in each period (e.g., one week, 24 hours, etc.), and therefore when a purchase request for a specific product is requested, competitive bidding may be carried out by selecting bid application information that matches the product.

In a procedure of the competitive bidding, the bidding unit 42 enables a bidding information blockchain to be generated in the blockchain network 100 by generation of a transaction related to the competitive bidding, and accordingly all information on the competitive bidding or information limited according to a configuration is stored in the blockchain network 100.

The delivery unit 43 processes product delivery.

More specifically, after a supplier is selected via competitive bidding, when it is determined that a follow-up procedure for product purchase, such as payment of a purchase price, has been completed, the delivery unit 43 enables product delivery to be processed between the purchaser and the supplier.

Here, due to the nature of the blockchain network 10, it is possible to process payment of the purchase price via a scheme of remitting (transferring) electronic money issued from the blockchain network 10 between a purchaser and a supplier.

When a delivery request is received from a distributor having confirmed delivery information from the bidding information blockchain of the blockchain network 10, the delivery unit 43 allows, by approving the delivery request, delivery to be proceeded via the distributor, and tracks a delivery state of the product until the delivery of the product is completed.

Only a distributor having configured, as a delivery available area, a delivery request area designated on the basis of a location of at least one of the purchaser and the supplier may confirm the delivery information.

That is, the delivery information is recorded as a transaction block in the bidding information blockchain, wherein the transaction block matches electronic wallet address information of the distributor having configured, as the delivery available area, the delivery request area designated on the basis of the location of at least one of the purchaser and the supplier when the competitive bidding is completed.

The distributor may confirm delivery information matching his/her own electronic wallet address information from the blockchain network 100, and if multiple bidding information blockchains have been generated in the blockchain network 100, the distributor may collectively confirm the delivery information matching his/her own electronic wallet address information.

By generating a transaction related to delivery in this delivery procedure, the delivery unit 43 causes generation of a service completion blockchain in which the transaction block is added to the bidding information blockchain, and accordingly all information relating to the delivery or information limited according to the configuration may be recorded and stored in the blockchain network 100.

For reference, in the service completion blockchain generated in the form where a transaction block is added in the bidding information blockchain, evaluation information obtained by evaluation of the purchaser with respect to at least one of the supplier and the distributor may be recorded as a transaction block, and the evaluation information may be used as, for example, information for restricting the supplier's participation in competitive bidding or restricting the distributor's request for delivery.

It has been mentioned that each element in the aforementioned electronic commerce service device 40 may be implemented in the form of a software module or a hardware module executed by the processor, or may be implemented in the form of a combination of a software module and a hardware module.

A software module, a hardware module, or a combination of a software module and a hardware module executed by the processor may be implemented as an actual hardware system (e.g., a computer system).

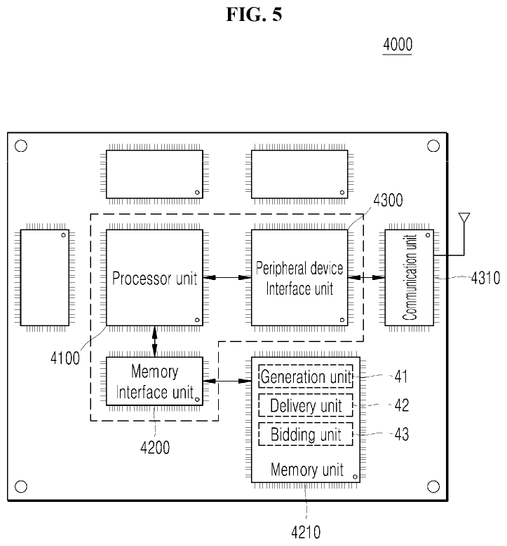

Accordingly, hereinafter, a hardware system 4000, in which the electronic commerce service device 40 according to the first embodiment of the present disclosure is implemented in a hardware form, will be described with reference to FIG. 5.

For reference, the contents to be described below is an example of implementing, as the hardware system 4000, each element within the aforementioned electronic commerce service device 40, and it should be kept in mind that each element and a resulting operation thereof may differ from an actual system.

As illustrated in FIG. 5, the hardware system 4000 according to the first embodiment of the present disclosure may include a processor unit 4100, a memory interface unit 4200, and a peripheral device interface unit 4300.

Each element in the hardware system 4000 may be an individual part or may be integrated into one or more integrated circuits, and each of these elements may be combined by a bus system (not illustrated).

The bus system is abstraction representing multi-drop or point-to-point connections, communication lines/interfaces, and/or any one or more individual physical buses connected by appropriate bridges, adapters, and/or controllers.

The processor unit 4100 executes various software modules stored in a memory unit 4210, by communicating with the memory unit 4210 via the memory interface unit 4200 in order to perform various functions in the hardware system.

Here, in the memory unit 4210, the generation unit 41, the bidding unit 42, and the delivery unit 43 which are respective elements of the electronic commerce service device 40 described with reference to FIG. 4 may be stored in the form of software modules, and an operating system (OS) may be additionally stored.

The operating system (e.g., iOS, Android, Darwin, RTXC, LINUX, UNIX, OS X, WINDOWS, or embedded operating system such as VxWorks) includes various procedures, instruction sets, software components and/or drivers which control and manage common system operations(for example, memory management, storage device control, power management, etc.), and serves to facilitate communication between various hardware modules and software modules.

For reference, the memory unit 4210 includes a cache, a main memory, and a secondary memory, but may include a memory hierarchy that is not limited thereto, wherein the memory hierarchy is implemented via, for example, any combination of RAM (e.g., SRAM, DRAM, or DDRAM), ROM, FLASH, magnetic, and/or an optical storage device [e.g., disk drive, magnetic tape, compact disk (CD), digital video disk (DVD), etc.].

The peripheral device interface unit 4300 serves to enable communication between the processor unit 4100 and a peripheral device.

The peripheral device is for providing different functions to the hardware system 4000, and in the first embodiment of the present disclosure, for example, the communication unit 4310 may be included.

The communication unit 4310 serves to provide a communication function with another device, and to this end, the communication unit 1310 includes, for example, an antenna system, an RF transceiver, one or more amplifiers, a tuner, one or more oscillators, a digital signal processor, a codec chipset, a memory, etc., but is not limited thereto. Further, the communication unit 1310 may include a known circuit that performs this function.

Communication protocols supported by the communication unit 4310 may include, for example, wireless LAN (WLAN), digital living network alliance (DLNA), wireless broadband (Wibro), world interoperability for microwave access (Wimax), global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), IEEE 802.16, long term evolution (LTE), long term evolution-advanced (LTE-A), wireless mobile broadband service (WMBS), Bluetooth, radio frequency identification (RFID), infrared communication (infrared data association: IrDA), ultra-wideband (UWB), ZigBee, near field communication (NFC), ultra sound communication (USC), visible light communication (VLC), Wi-Fi, Wi-Fi Direct, and the like. A wired communication network may include wired local area network (LAN), wired wide area network (WAN), power line communication (PLC), USB communication, Ethernet, serial communication, optical/coaxial cable, and the like, but may not be limited thereto. Further, any protocol capable of providing an environment of communication with other devices may be included.

Each element within the electronic commerce service device 40, which is stored in the form of software module in the memory unit 4210 in the hardware system 4000 according to the first embodiment of the present disclosure may perform, on the basis of instructions executed by the processor unit 4100, interface with the communication unit 4310 via the memory interface unit 4200 and the peripheral device interface unit 4300, thereby providing a competitive bidding-based electronic commerce service to the purchaser.

As described above, according to the electronic commerce service system and each element within the system in accordance with the first embodiment of the present disclosure, it may be seen that the stability and satisfaction in an electronic commerce service for product purchase and delivery can be improved by selecting, via competitive bidding, a supplier of a product requested for purchase by a purchaser, so as to process product delivery between the supplier and the purchaser in a blockchain network environment.

Hereinafter, descriptions of the electronic commerce service system and an operation flow of each element in the system according to the first embodiment of the present disclosure will be continued.

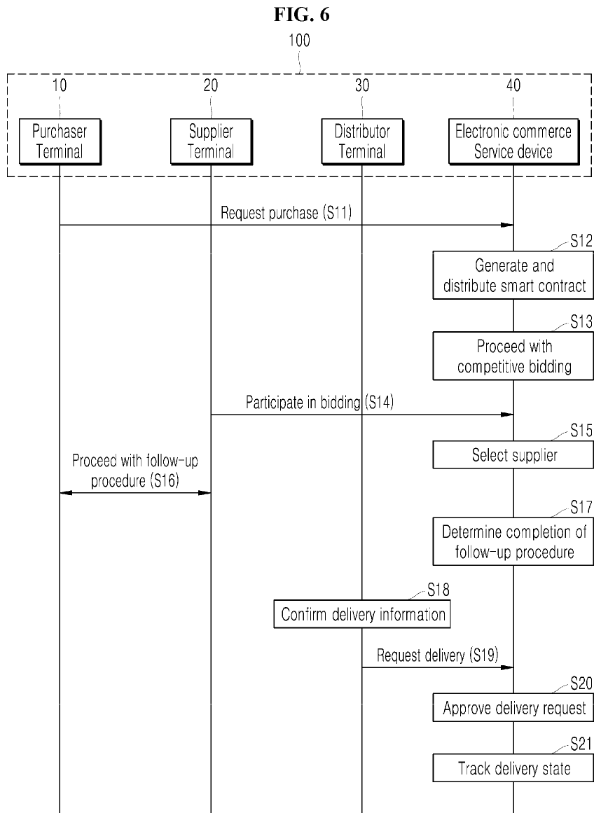

FIG. 6 shows an operation flow in the electronic commerce service system according to the first embodiment of the present disclosure.

First, the purchaser terminal 10 transfers a purchase request for a specific product to the electronic commerce service device 40 (S11).

The purchaser terminal 10 may configure additional information, such as specific details (e.g., 1000 ml of milk) of a specific product desired to be purchased, a bidding scheme, such as general competitive bidding, limited competitive bidding, and nominated competitive bidding, a delivery address, and a delivery fee payment method.

Subsequently, when the purchase request for the specific product is received from the purchaser terminal 10, the electronic commerce service device 40 may generate a smart contract for the purchase request and distribute the same to blockchain network 100, so as to enable competitive bidding and delivery to be processed according to the distributed smart contract (S12).

Then, in response to the purchase request for the specific product received from the purchaser terminal 10, the electronic commerce service device 40 proceeds with competitive bidding for a supply price of the product, and selects the supplier terminal 20 having proposed the most reasonable supply price, as a supplier of the specific product that the purchaser terminal 10 has requested to purchase (S13-S15).

In a procedure of the competitive bidding, the electronic commerce service device 40 enables a bidding information blockchain to be generated in the blockchain network 100 by generation of a transaction related to the competitive bidding, and accordingly all information on the competitive bidding or information limited according to a configuration is stored in the blockchain network 100.

Furthermore, when a supplier has been selected via competitive bidding, the purchaser terminal 10 performs a follow-up procedure for product purchase, such as payment of a purchase price, so as to enable product delivery to be processed (S16).

Here, due to the nature of the blockchain network 10, it is possible to process payment of the purchase price via a scheme of remitting (transferring) electronic money issued from the blockchain network 10 between a purchaser and a supplier.

Thereafter, when it is determined that the follow-up procedure for product purchase has been completed, the electronic commerce service device 40 processes the product delivery (S17-S21).

When a delivery request is received from the distributor terminal 30 having confirmed delivery information from the bidding information blockchain of the blockchain network 10, the electronic commerce service device 40 allows, by approving the delivery request, delivery to be proceeded via the distributor, and tracks a delivery state of the product until the delivery of the product is completed.

Only a distributor, who has configured, as a delivery available area, a delivery request area designated on the basis of a location of at least one of the purchaser and the supplier, may confirm the delivery information.

That is, the delivery information is recorded as a transaction block in the bidding information blockchain, wherein the transaction block matches electronic wallet address information of the distributor having configured, as the delivery available area, the delivery request area designated on the basis of the location of at least one of the purchaser and the supplier when the competitive bidding is completed.

The distributor terminal 30 may confirm delivery information matching the distributor's own electronic wallet address information from the blockchain network 100, and if multiple bidding information blockchains have been generated in the blockchain network 100, the distributor terminal 30 may collectively confirm the delivery information matching the distributor's own electronic wallet address information.

By generating a transaction related to delivery in this delivery procedure, the electronic commerce service device 40 causes generation of a service completion blockchain in which the transaction block is added to the bidding information blockchain, and accordingly all information relating to the delivery or information limited according to the configuration may be recorded and stored in the blockchain network 100.

The description of the operation flow in the electronic commerce service system according to the first embodiment of the present disclosure has been finished, and the description of the operation flow in the purchaser terminal 10 will be continued.

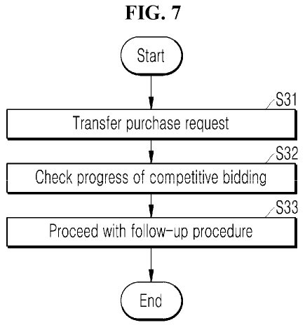

FIG. 7 shows an operation flow in the purchaser terminal 10 according to the first embodiment of the present disclosure.

First, the request unit 11 transfers a purchase request for a specific product to the electronic commerce service device 40 (S31).

In this regard, when the purchase request for the specific product is received from the purchaser terminal 10, the electronic commerce service device 40 may generate a smart contract for the purchase request and distribute the same to blockchain network 100, so as to enable competitive bidding and delivery to be processed according to the distributed smart contract.

The requesting unit 11 may configure, for example, additional information, such as specific details (e.g., 1000 ml of milk) of the specific product desired to be purchased, a bidding scheme, such as general competitive bidding, limited competitive bidding, and nominated competitive bidding, a delivery address, and a delivery fee payment method, and this configuration information is reflected in the smart contract generated by the electronic commerce service device 40.

Then, the checking unit 12 allows a purchaser to check the progress of a competitive bidding procedure in the electronic commerce service device 40 in response to a purchase request for a specific product (S32).

In this regard, in response to the purchase request for the specific product received from the purchaser terminal 10, the electronic commerce service device 40 proceeds with competitive bidding for a supply price of the product, and selects a bidder having proposed the most reasonable supply price, as a supplier of the specific product that the purchaser terminal 10 has requested to purchase.

In a procedure of the competitive bidding, the electronic commerce service device 40 enables a bidding information blockchain to be generated in the blockchain network 100 by generation of a transaction related to the competitive bidding, and accordingly all information on the competitive bidding or information limited according to a configuration is stored in the blockchain network 100.

Thereafter, when a supplier has been selected via competitive bidding, the processing unit 13 performs a follow-up procedure for product purchase, such as payment of a purchase price, so as to enable product delivery to be processed (S33).

Here, due to the nature of the blockchain network 10, it is possible to process payment of the purchase price via a scheme of remitting (transferring) electronic money issued from the blockchain network 10 between a purchaser and a supplier.

In this regard, after selection of the supplier, when it is determined that the follow-up procedure for product purchase has been completed, the electronic commerce service device 40 processes the product delivery.

When a delivery request is received from a distributor having confirmed delivery information from the bidding information blockchain of the blockchain network 10, the electronic commerce service device 40 allows, by approving the delivery request, delivery to be proceeded via the distributor, and tracks a delivery state of the product until the delivery of the product is completed.

Only a distributor, who has configured, as a delivery available area, a delivery request area designated on the basis of a location of at least one of the purchaser and the supplier, may confirm the delivery information.

That is, the delivery information is recorded as a transaction block in the bidding information blockchain when the competitive bidding is completed, wherein the transaction block matches electronic wallet address information of the distributor who has configured a corresponding area as the delivery available area according to the delivery request area designated on the basis of the location of at least one of the purchaser and the supplier.

The distributor may confirm delivery information matching his/her own electronic wallet address information from the blockchain network 100, and if multiple bidding information blockchains have been generated in the blockchain network 100, the distributor may collectively confirm the delivery information matching his/her own electronic wallet address information.

By generating a transaction related to delivery in this delivery procedure, the electronic commerce service device 40 causes generation of a service completion blockchain in which the transaction block is added to the bidding information blockchain, and accordingly all information relating to the delivery or information limited according to the configuration may be recorded and stored in the blockchain network 100.

The description of the operation flow in the purchaser terminal 10 according to the first embodiment of the present disclosure has been finished, and the description of the operation flow in the electronic commerce service device 40 will be continued.

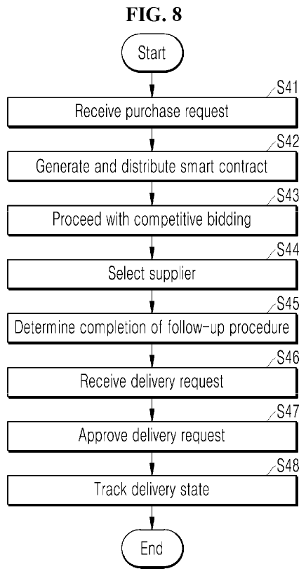

FIG. 8 shows an operation flow in the electronic commerce service device 40 according to the first embodiment of the present disclosure.

First, when a purchase request for a specific product is received from the purchaser terminal 10, the generation unit 41 generates a smart contract for the purchase request and distributes the same to blockchain network 100, so as to enable competitive bidding and delivery to be processed according to the distributed smart contract (S41-S42).

The purchaser terminal 10 may configure, for example, additional information, such as specific details (e.g., 1000 ml of milk) of the specific product desired to be purchased, a bidding scheme, such as general competitive bidding, limited competitive bidding, and nominated competitive bidding, a delivery address, and a delivery fee payment method, and this configuration information may be reflected in the smart contract generated for competitive bidding and delivery processing.

Furthermore, when a smart contract for the purchase request for the specific product received from the purchaser terminal 10 is generated, the bidding unit 42 proceeds with competitive bidding according to contents of the smart contract (S43-S44).

The bidding unit 42 selects a bidder, who has proposed the most reasonable supply price for the specific product requested by a purchaser, as a supplier of the specific product requested by the purchaser terminal 10 from among bidders participating in the competitive bidding.

Here, the competitive bidding is based on real-time participation of a bidder, but it is also possible to proceed with the competitive bidding by selecting pre-registered bidding application information, as an exception.

For example, if the remaining time until the end of the competitive bidding is less than a threshold time, and the number of bidders participating in the competitive bidding is less than a threshold number, the competitive bidding for the remaining time may be proceeded with by selecting the pre-registered bid application information.

If the time, at which a purchase request is received from the purchaser terminal 10, is early morning. etc., and it is thus difficult for a bidder to participate in bidding in real time, it is also possible to proceed with competitive bidding by selecting pre-registered bid application information regardless of the remaining time until the end of the competitive bidding.

To this end, the bidding unit 42 pre-registers, as bidding application information, a supply price suggested by a bidder for each product, and updates and manages the same in each period (e.g., one week, 24 hours, etc.), and therefore when a purchase request for a specific product is requested, competitive bidding may be carried out by selecting bid application information that matches the product.

In a procedure of the competitive bidding, the bidding unit 42 enables a bidding information blockchain to be generated in the blockchain network 100 by generation of a transaction related to the competitive bidding, and accordingly all information on the competitive bidding or information limited according to a configuration is stored in the blockchain network 100.

Subsequently, after a supplier is selected via competitive bidding, when it is determined that a follow-up procedure for product purchase, such as payment of a purchase price, has been completed, the delivery unit 43 enables product delivery to be processed between the purchaser and the supplier (S45-S48).

That is, when a delivery request is received from a distributor having confirmed delivery information from the bidding information blockchain of the blockchain network 10, the delivery unit 43 allows, by approving the delivery request, delivery to be proceeded via the distributor, and tracks a delivery state of the product until the delivery of the product is completed.

Only a distributor having configured, as a delivery available area, a delivery request area designated on the basis of a location of at least one of the purchaser and the supplier may confirm the delivery information.

That is, the delivery information is recorded as a transaction block in the bidding information blockchain, wherein the transaction block matches electronic wallet address information of the distributor having configured, as the delivery available area, the delivery request area designated on the basis of the location of at least one of the purchaser and the supplier when the competitive bidding is completed.

The distributor may confirm delivery information matching his/her own electronic wallet address information from the blockchain network 100, and if multiple bidding information blockchains have been generated in the blockchain network 100, the distributor may collectively confirm the delivery information matching his/her own electronic wallet address information.

By generating a transaction related to delivery in this delivery procedure, the delivery unit 43 causes generation of a service completion blockchain in which the transaction block is added to the bidding information blockchain, and accordingly all information relating to the delivery or information limited according to the configuration may be recorded and stored in the blockchain network 100.

For reference, in the service completion blockchain generated in the form where a transaction block is added in the bidding information blockchain, evaluation information obtained by evaluation of the purchaser with respect to at least one of the supplier and the distributor may be recorded as a transaction block, and the evaluation information may be used as, for example, information for restricting the supplier's participation in competitive bidding or restricting the distributor's request for delivery.

As described above, according to the operation method of each element in the electronic commerce service system according to the first embodiment of the present disclosure, it may be seen that the stability and satisfaction in an electronic commerce service for product purchase and delivery can be improved by selecting, via competitive bidding, a supplier of a product requested for purchase by a purchaser, so as to process product delivery between the supplier and the purchaser in a blockchain network environment.

Hereinafter, a second embodiment of the present disclosure will be described with reference to the accompanying drawings.

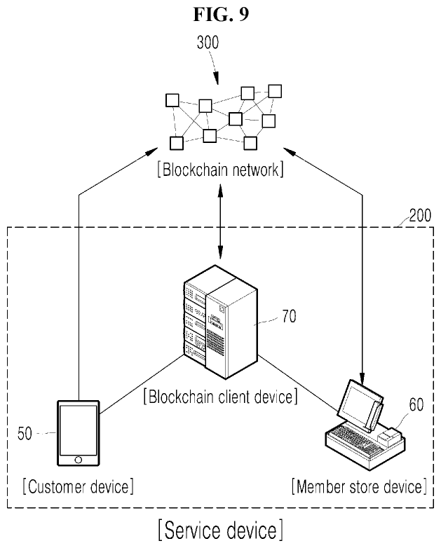

FIG. 9 is a diagram illustrating a member store service system according to the second embodiment of the present disclosure.

As illustrated in FIG. 1, the member store service system according to the second embodiment of the present disclosure may include a service device 200 configured to process a service request from a customer or a member store in association with a blockchain network 300.

As described above, the service device 200 may be a customer device 50 configured to process a service request from a customer, or a member store device 60 configured to process a service request from a member store.

If the customer device 50 and the member store device 60 have no blockchain data, the service device 200 may be a blockchain client device 70 that is a device for connecting the customer device 50 or the member store device 60 to the blockchain network 300.

As such, it may be understood that the service device 200, which may be referred to as the customer device 50, the member store device 60, and the blockchain client device 70, is a single blockchain node constituting the blockchain network.

The service device 200 may include, for example, a mobile terminal such as a smartphone, a notebook computer, a desktop, a laptop, a wired or wireless mobile or fixed controller having a user interface, a server, or the like and, of course, the service device 200 is not limited thereto and may include all types of devices equipped with computing means and communication means.

For reference, in a case where the service device 200 is implemented in the form of a server, implementation may be performed in the form of, for example, a web server, a database server, a proxy server, etc., and one or more pieces of various software may be installed, via which a computerized system may also be implemented, wherein the various software enables a network load balancing mechanism and operation of the service device on the Internet or other networks.

The network may be an http network and may be a private line, an intranet, or any other network. Connections between respective elements within the member store service system according to the second embodiment of the present disclosure may be established via a security network so as to prevent data from being attacked by any hacker or other third party.

In this blockchain network 300, continuously increasing data is recorded in a specific unit of block, and respective participant nodes constituting a peer-to-peer (P2P) network may manage corresponding blocks in a chain-type data structure.

Blockchain data configured by the chain-type data structure is operated in the form of a distributed ledger at each node without a central system.

In respective nodes constituting the blockchain network, blocks are managed in a chain form on the basis of a data structure of recording a hash value of a previous block in a current block, and the previous block may be thus referred via the hash value.

Therefore, as more blocks managed in the chain form in respective nodes are accumulated, forgery and alteration of transaction data recorded in the block becomes difficult, and the reliability of transaction data recorded in respective blocks may be improved.

In particular, the blockchain network 300 according to the second embodiment of the present disclosure follows, for example, an Ethereum environment which enables the blockchain technology to be applied to various application service fields on the basis of a smart contract.

Here, Ethereum provides a standard technology, such as decentralized application (Dapp), which enables integration into an Ethereum cryptocurrency system even if a new cryptocurrency is created in any application field.

In other words, Ethereum becomes, for example, via a role of an operating system such as the Android OS for smartphones, a base technology for various applications running on a blockchain, just as the Android OS becomes the basis for mobile applications in smartphones, which are used by users.

Here, all applications implemented on a blockchain are referred to as decentralized applications, that is, Dapps, and it is thus possible to apply the blockchain technology to various application service fields via Dapps and smart contracts in the Ethereum environment.

Accordingly, in the second embodiment of the present disclosure, the blockchain technology is applied to a member store service field on the basis of the scalability of Ethereum. Hereinafter, more specific descriptions will be provided regarding configurations of the service device 200 for implementing application of the blockchain technology, specifically, the configurations of the customer device 50 and the member store device 60.

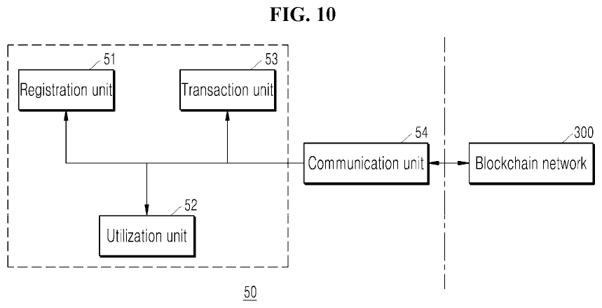

FIG. 10 shows a configuration of the customer terminal 50 according to the second embodiment of the present disclosure.

As illustrated in FIG. 10, the customer device 50 according to the second embodiment of the present disclosure may include a registration unit 51 configured for membership registration for a member store, and a utilization unit 52 configured for use of a service provided by a member store.

The customer device 50 according to the second embodiment of the present disclosure may further include a transaction unit 53 configured for electronic money transaction.

All or at least some elements of the customer device 50 including the registration unit 51, the utilization unit 52, and the transaction unit 53 may be implemented in the form of a software module or a hardware module executed by the processor or may also be implemented in the form of a combination of a software module and a hardware module.

In particular, these elements are for using a member store service in association with the blockchain network 300, and may be subjects that maintain and manage blockchain data on the basis of a blockchain algorithm, which can be implemented in the form of a decentralized application, that is, a decentralized application (Dapp).

In addition to the aforementioned elements, the customer device 50 according to the second embodiment of the present disclosure may further include a communication unit 54 that is an RF module for practical communication with the blockchain network 300.

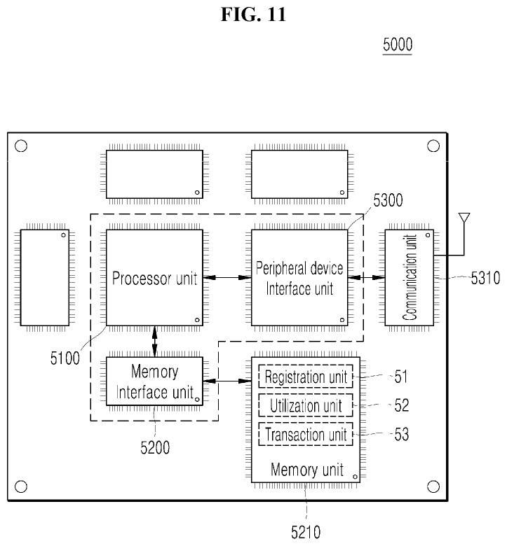

For reference, a configuration of the communication unit 54 corresponds to the communication unit 5310 to be described with reference to FIG. 11, and therefore a detailed description will be provided below.

The customer device 50 according to the second embodiment of the present disclosure may support storage of customer data in the blockchain network 300 according to the use of the member store service via the aforementioned elements, and may restrict access to the customer data stored in the blockchain network 300, and more specific details will follow regarding the respective elements within the customer device 50, which are for realizing the same.

The registration unit 51 processes membership registration for a customer.

More specifically, the registration unit 51 transfers, to the member store device 60, information input from a customer according to a membership registration procedure required from the member store device 60, so as to process membership registration for a member store.

The registration unit 51 may transfer, for example, basic customer information (e.g., ID, password, name, gender, address, interests, etc.), customer identification information, and access configuration information.

The customer identification information is information for customer identification in the blockchain network 300, and may correspond to, for example, an electronic wallet address and an authentication key (public key/private key) which are given to a customer in order to identify the customer in the blockchain network 300.

The access configuration information is information for restricting access to customer data in the blockchain network 300 on the basis of an intention of a customer according to the second embodiment of the present disclosure, and may be configured including, for example, whether information collection is allowed for each information collection medium, and a type of customer data, from which information can be collected by a specific information collection medium.

The type of customer data may be classified as respective pieces of service identification information according to a type of a service (purchase, search, sale, etc.) used by a customer in the member store device 60.

Accordingly, for the access configuration information, whether information collection is allowed for a specific information collection medium, and one or more types of customer data, from which information can be collected, when information collection is allowed may be configured as service identification information reflecting the intention of the customer.

The access configuration information is generated by being included in a smart contract for each customer, which defines a series of procedures according to an information collection request received from an information collection medium, and is distributed to the blockchain network 300, so as to be stored as one transaction block.

The smart contract is stored as a transaction block matching customer identification information, and may be generated including, for example, an information collection condition, an information permission policy, and an information reward policy.

Here, it may be understood that the information collection condition is information on whether information collection is allowed for a specific information collection medium and information on the amount of electronic money required to be paid for information collection, the information permission policy is information on the type of customer data which can be collected by a specific information collection medium permitted for information collection, and the information reward policy is information for transferring of rewards for information collection to the customer.

The utilization unit 52 processes use of a service provided by a member store.

More specifically, when a service provided by a member store is used after membership registration, the utilization unit 52 transfers personal identification information of a customer to the member store device 60, thereby enabling the member store device 60, which has received the personal identification information, to match the personal identification information with customer data (e.g., log information) based on service use, so as to store the matched data and information as a transaction block in the blockchain network 300.

As described above, the customer data may be classified as two or more pieces of service identification information according to the type of the service provided by the member store, and when a specific customer uses two or more services, an individual transaction block matching each piece of the service identification information may be generated, or a single transaction block irrelevant to the service identification information may be integratedly generated and stored in the blockchain network 300.

The transaction unit 53 processes electronic money transaction.

More specifically, when the transaction unit 53 collects customer data from an information collection medium, the transaction unit 53 receives, from the member store device 60, electronic money configured as rewards accordingly.

In this regard, when the information collection medium has collected customer data, the member store device 60 transfers electronic money issued from the blockchain network 300 to an electronic wallet address of the customer device 50 according to the information reward policy in a smart contract.

Here, the electronic money provided as rewards may be, for example, electronic money issued in response to a request of the member store device 60, or may be a part of the amount of electronic money paid for information collection by the information collection medium according to the information reward policy in the smart contract.

It has been mentioned that each element in the customer device 50 described above may be implemented in the form of a software module or a hardware module executed by the processor, or may be implemented in the form of a combination of a software module and a hardware module.

A software module, a hardware module, or a combination of a software module and a hardware module executed by the processor may be implemented as an actual hardware system (e.g., a computer system).

Accordingly, hereinafter, a description will be given of a hardware system 5000, in which the customer device 50 according to the second embodiment of the present disclosure is implemented in a hardware form, with reference to FIG. 11.

For reference, the contents to be described below is an example of implementing, as the hardware system 5000, each element within the aforementioned customer device 50, and it should be kept in mind that each element and a resulting operation thereof may differ from an actual system.

As illustrated in FIG. 11, the hardware system 5000 according to the second embodiment of the present disclosure may include a processor unit 5200, a memory interface unit 5300, and a peripheral device interface unit 5300.

Each element in the hardware system 5000 may be an individual part or may be integrated into one or more integrated circuits, and each of these elements may be combined by a bus system (not illustrated).

The bus system is abstraction representing multi-drop or point-to-point connections, communication lines/interfaces, and/or any one or more individual physical buses connected by appropriate bridges, adapters, and/or controllers.

The processor unit 5200 executes various software modules stored in a memory unit 5210, by communicating with the memory unit 5210 via the memory interface unit 5300 in order to perform various functions in the hardware system.

Here, in the memory unit 5210, the registration unit 51, the utilization unit 12, and the transaction unit 12 which are elements of the customer terminal 50 described with reference to FIG. 10 may be stored in the form of software modules, and an operating system (OS) may be additionally stored.

The operating system (e.g., iOS, Android, Darwin, RTXC, LINUX, UNIX, OS X, WINDOWS, or embedded operating system such as VxWorks) includes various procedures, instruction sets, software components and/or drivers which control and manage common system operations(for example, memory management, storage device control, power management, etc.), and serves to facilitate communication between various hardware modules and software modules.

For reference, the memory unit 5210 includes a cache, a main memory, and a secondary memory, but may include a memory hierarchy that is not limited thereto, wherein the memory hierarchy is implemented via, for example, any combination of RAM (e.g., SRAM, DRAM, or DDRAM), ROM, FLASH, magnetic, and/or an optical storage device [e.g., disk drive, magnetic tape, compact disk (CD), digital video disk (DVD), etc.].

The peripheral device interface unit 5300 serves to enable communication between the processor unit 5200 and a peripheral device.

The peripheral device is for providing different functions to the hardware system 5000, and in the second embodiment of the present disclosure, for example, the communication unit 5310 may be included.

The communication unit 5310 serves to provide a communication function with another device, and to this end, the communication unit 1310 includes, for example, an antenna system, an RF transceiver, one or more amplifiers, a tuner, one or more oscillators, a digital signal processor, a codec chipset, a memory, etc., but is not limited thereto. Further, the communication unit 1310 may include a known circuit that performs this function.

Communication protocols supported by the communication unit 5310 may include, for example, wireless LAN (WLAN), digital living network alliance (DLNA), wireless broadband (Wibro), world interoperability for microwave access (Wimax), global system for mobile communication (GSM), code division multi access (CDMA), code division multi access 3000 (CDMA3000), enhanced voice-data optimized or enhanced voice-data only (EV-DO), wideband CDMA (WCDMA), high speed downlink packet access (HSDPA), high speed uplink packet access (HSUPA), IEEE 802.16, long term evolution (LTE), long term evolution-advanced (LTE-A), wireless mobile broadband service (WMBS), Bluetooth, radio frequency identification (RFID), infrared communication (infrared data association: IrDA), ultra-wideband (UWB), ZigBee, near field communication (NFC), ultra sound communication (USC), visible light communication (VLC), Wi-Fi, Wi-Fi Direct, and the like. A wired communication network may include wired local area network (LAN), wired wide area network (WAN), power line communication (PLC), USB communication, Ethernet, serial communication, optical/coaxial cable, and the like, but may not be limited thereto. Further, any protocol capable of providing an environment of communication with other devices may be included.

Each element within the customer device 50, which is stored in the form of software module in the memory unit 5210 in the hardware system 5000 according to the second embodiment of the present disclosure may perform, on the basis of instructions executed by the processor unit 5200, interface with the communication unit 5310 via the memory interface unit 5300 and the peripheral device interface unit 5300, thereby restricting access to customer data stored in the blockchain network 300.

The description of the configuration of the customer device 50 according to the second embodiment of the present disclosure has been finished, and the description of the configuration of the member store device 60 will be continued.

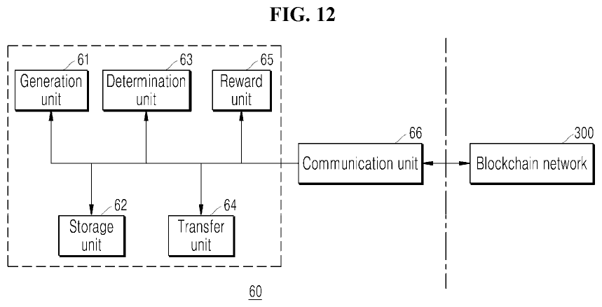

FIG. 12 shows a schematic configuration of the member store device 60 according to according to the second embodiment of the present disclosure.

As illustrated in FIG. 12, the member store device 60 according to the second embodiment of the present disclosure may include a generation unit 61 configured to generate a smart contract for a customer, a storage unit 62 configured to store customer data, a determination unit 63 configured to determine whether information collection is possible, and a transfer unit 64 configured to process information transfer.

The member store device 60 according to the second embodiment of the present disclosure may further include a reward unit 65 configured to process a reward according to information collection.

All or at least some elements of the member store device 60 including the generation unit 61, the storage unit 62, the determination unit 63, the transfer unit 64, and the reward unit 65 may be implemented in the form of a software module or a hardware module executed by the processor or may also be implemented in the form of a combination of a software module and a hardware module.

In particular, these elements are for processing a member store service via association with the blockchain network 300, and may be subjects that maintain and manage blockchain data on the basis of a blockchain algorithm, which can be implemented in the form of a decentralized application, that is, a decentralized application (Dapp).

In addition to the aforementioned elements, the member store device 60 according to the second embodiment of the present disclosure may further include a communication unit 66 that is an RF module for practical communication with the blockchain network 300.

For reference, a configuration of the communication unit 66 corresponds to the communication unit 6310 to be described with reference to FIG. 11, and therefore a detailed description will be provided below.

As a result, the member store device 60 according to the second embodiment of the present disclosure may process an information collection request for a customer, which is received from an information collection medium via the aforementioned element, and each element within the member store device 60 for realizing this will be described in more detail in the following.

The generation unit 61 generates a smart contract for a customer.

More specifically, the generation unit 61 generates a smart contract for a customer by reflection of information received from the customer device 50 according to a membership subscription procedure.

The information received from the customer device 50 may include, for example, basic customer information (e.g., ID, password, name, gender, address, interests, etc.), customer identification information, and access configuration information.

The customer identification information is information for customer identification in the blockchain network 300, and may correspond to, for example, an electronic wallet address and an authentication key (public key/private key) which are given to a customer in order to identify the customer in the blockchain network 300.

The access configuration information is information for restricting access to customer data in the blockchain network 300 on the basis of an intention of a customer according to the second embodiment of the present disclosure, and may be configured including, for example, whether information collection is allowed for each information collection medium, and a type of customer data, from which information can be collected by a specific information collection medium.

The type of customer data may be classified as respective pieces of service identification information according to a type of a service (purchase, search, sale, etc.) used by a customer in the member store device 60.

Accordingly, for the access configuration information, whether information collection is allowed for a specific information collection medium, and one or more types of customer data, from which information can be collected, when information collection is allowed may be configured as service identification information reflecting the intention of the customer.

The generation unit 61 may reflect the access configuration information, may generate a smart contract including, for example, an information collection condition, an information permission policy, and an information reward policy, and may store the same as a transaction block matching customer identification information in the blockchain network 300.

Here, it may be understood that the information collection condition is information on whether information collection is allowed for a specific information collection medium and information on the amount of electronic money required to be paid for information collection, the information permission policy is information on the type of customer data which can be collected by a specific information collection medium permitted for information collection, and the information reward policy is information for transferring of rewards for information collection to the customer.

The storage unit 62 stores customer data.

More specifically, when a service is used in the customer device 50 after membership registration, the storage unit 62 matches customer data (e.g., log information) based on the service use with customer identification information received from the customer device 50, so as to store the matched data and information as a transaction block in the blockchain network 300.

As described above, the customer data is classified as two or more pieces of service identification information according to a type of the service provided by the member store.

Therefore, when two or more services are used in the customer device 50, the storage unit 62 may generate an individual transaction block matching each piece of service identification information, or may integratedly generate a single transaction block irrelevant to the service identification information, so as to store the generated transaction block in the blockchain network 300.

The determination unit 63 determines whether information collection is possible.

More specifically, the determination unit 63 determines whether information collection is possible, in response to an information collection request for a customer, which is received from an information collection medium.

That is, the determination unit 63 checks the information collection condition from the smart contract distributed to the blockchain network 20, and determines whether the information collection medium having requested information collection satisfies the information collection condition.

The determination unit 63 may determine that information collection by the information collection medium is allowed according to the information collection condition, and when it is confirmed that a certain amount of electronic money has been paid for information collection, information collection by the information collection medium is possible.

The transfer unit 64 transfers customer data to an information collection medium.

More specifically, when it is determined that information collection is possible for the information collection medium, the transfer unit 64 causes customer data stored in the blockchain network 300 to be transferred to the information collection medium.

That is, the transfer unit 64 checks the information permission policy from the smart contract distributed in the blockchain network 20, and causes at least a part of the entire specific customer, which is stored as a transaction block in the blockchain network 300, to be transferred to the information collection medium.

When the customer data is stored as an individual transaction block matching each piece of service identification information, the transfer unit 64 may check specific service identification information, from which information collection is permitted, according to the information permission policy, and may acquire and transfer the customer data from a transaction block matching the specific service identification information from among transaction blocks stored in the blockchain network 300.

When the customer data is integrated and stored as a single transaction block irrelevant to the service identification information, an information transfer filter is applied to transfer the customer data.

That is, the transfer unit 64 generates an information transfer filter to transfer customer data of specific service identification information, from which information collection is permitted, according to the information permission policy, and applies the information transfer filter to the entire customer data acquired from the transaction blocks of the blockchain network 300, so as to cause only the customer data of the specific service identification information to be transferred to the information collection medium.

Here, it may be understood that the information transfer filter is information for encrypting customer data of the remaining service identification information, excluding the customer data corresponding to the specific service identification information from among the entire customer data acquired from the transaction blocks of the blockchain network 300.

The reward unit 65 processes a reward for information collection.

More specifically, when customer data has been transferred to the information collection medium, the reward unit 65 transfers, as a reward, a certain amount of electronic money to the customer device 50 accordingly.

That is, the reward unit 65 checks the information reward policy from the smart contract distributed to the blockchain network 20, and transfers the electronic money issued from the blockchain network 300 to the customer device 50, as a reward for information collection according to the information reward policy.

Here, the electronic money provided as the reward may be, for example, electronic money issued in response to a request of the member store device 60, or may be a part of the amount of electronic money paid for information collection by the information collection medium according to the information reward policy in the smart contract.

It has been mentioned that each element in the aforementioned member store device 60 may be implemented in the form of a software module or a hardware module executed by the processor, or may be implemented in the form of a combination of a software module and a hardware module.

A software module, a hardware module, or a combination of a software module and a hardware module executed by the processor may be implemented as an actual hardware system (e.g., a computer system).

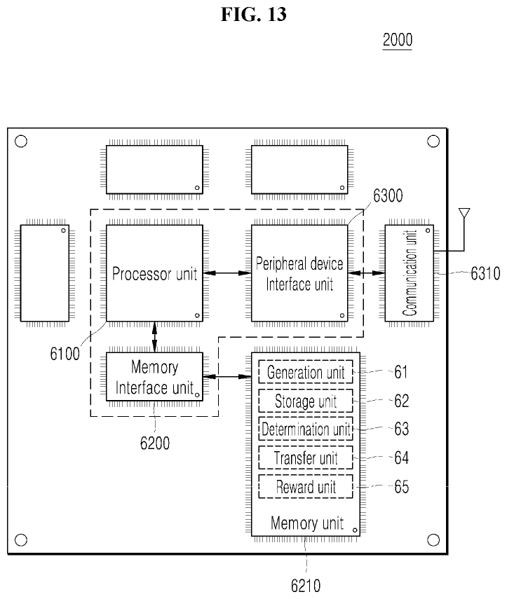

Accordingly, hereinafter, a description will be given of a hardware system 6000, in which the member store device 60 according to the second embodiment of the present disclosure is implemented in a hardware form, with reference to FIG. 13.

For reference, the contents to be described below is an example of implementing, as the hardware system 6000, each element within the aforementioned member store device 60, and it should be kept in mind that each element and a resulting operation thereof may differ from an actual system.

As illustrated in FIG. 13, the hardware system 6000 according to the second embodiment of the present disclosure may include a processor unit 6200, a memory interface unit 6300, and a peripheral device interface unit 6300.

Each element in the hardware system 6000 may be an individual part or may be integrated into one or more integrated circuits, and each of these elements may be combined by a bus system (not illustrated).

The bus system is abstraction representing multi-drop or point-to-point connections, communication lines/interfaces, and/or any one or more individual physical buses connected by appropriate bridges, adapters, and/or controllers.

The processor unit 6200 executes various software modules stored in a memory unit 6210, by communicating with the memory unit 6210 via the memory interface unit 6300 in order to perform various functions in the hardware system.

In the memory unit 6210, the generation unit 61, the storage unit 62, the determination unit 63, the transfer unit 64, and the reward unit 65, which are elements of the member store device 60 described with reference to FIG. 12 may be stored in the form of a software module, and an operating system (OS) may be additionally stored.

The operating system (e.g., iOS, Android, Darwin, RTXC, LINUX, UNIX, OS X, WINDOWS, or embedded operating system such as VxWorks) includes various procedures, instruction sets, software components and/or drivers which control and manage common system operations(for example, memory management, storage device control, power management, etc.), and serves to facilitate communication between various hardware modules and software modules.

For reference, the memory unit 6210 includes a cache, a main memory, and a secondary memory, but may include a memory hierarchy that is not limited thereto, wherein the memory hierarchy is implemented via, for example, any combination of RAM (e.g., SRAM, DRAM, or DDRAM), ROM, FLASH, magnetic, and/or an optical storage device [e.g., disk drive, magnetic tape, compact disk (CD), digital video disk (DVD), etc.].

The peripheral device interface unit 6300 serves to enable communication between the processor unit 6200 and a peripheral device.

The peripheral device is for providing different functions to the hardware system 6000, and in the second embodiment of the present disclosure, for example, the communication unit 6310 may be included.

The communication unit 6310 serves to provide a communication function with another device, and to this end, the communication unit 1310 includes, for example, an antenna system, an RF transceiver, one or more amplifiers, a tuner, one or more oscillators, a digital signal processor, a codec chipset, a memory, etc., but is not limited thereto. Further, the communication unit 1310 may include a known circuit that performs this function.

Communication protocols supported by the communication unit 6310 may include, for example, wireless LAN (WLAN), digital living network alliance (DLNA), wireless broadband (Wibro), world interoperability for microwave access (Wimax), global system for mobile communication (GSM), code division multi access (CDMA), code division multi access 3000 (CDMA3000), enhanced voice-data optimized or enhanced voice-data only (EV-DO), wideband CDMA (WCDMA), high speed downlink packet access (HSDPA), high speed uplink packet access (HSUPA), IEEE 802.16, long term evolution (LTE), long term evolution-advanced (LTE-A), wireless mobile broadband service (WMBS), Bluetooth, radio frequency identification (RFID), infrared communication (infrared data association: IrDA), ultra-wideband (UWB), ZigBee, near field communication (NFC), ultra sound communication (USC), visible light communication (VLC), Wi-Fi, Wi-Fi Direct, and the like. A wired communication network may include wired local area network (LAN), wired wide area network (WAN), power line communication (PLC), USB communication, Ethernet, serial communication, optical/coaxial cable, and the like, but may not be limited thereto. Further, any protocol capable of providing an environment of communication with other devices may be included.

Each element within the service device 20, which is stored in the form of software module in the memory unit 6210 in the hardware system 6000 according to the second embodiment of the present disclosure may perform, on the basis of instructions executed by the processor unit 6200, interface with the communication unit 6310 via the memory interface unit 6300 and the peripheral device interface unit 6300, thereby processing of an information collection request for a customer, which is received from an information collection medium.

As described above, according to the member store service system and respective elements within the system according to the second embodiment of the present disclosure, it may be seen that customer data related to use of a service of a member store is stored in a blockchain network, and collection (viewing) of the customer data stored in the blockchain network may be restricted on the basis of customer settings, so that stable use of the customer data is possible on the basis of the stability and reliability of the blockchain technology and an intention of a customer.

Hereinafter, descriptions of the member store service system and an operation flow of each element in the system according to the second embodiment of the present disclosure will be continued.

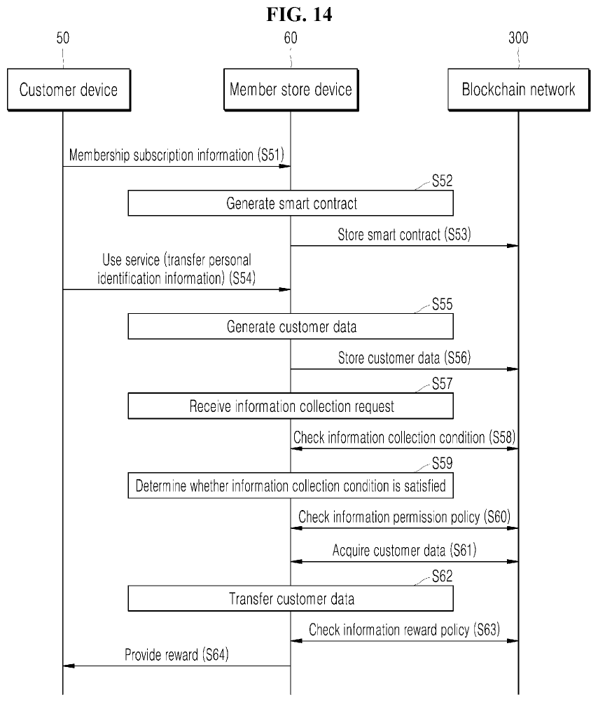

FIG. 14 shows an operation flow in the member store service system according to the second embodiment of the present disclosure.

First, the customer device 50 transfers, to the member store device 60, information that is input from a customer according to a membership subscription procedure required from the member store device 20, so as to process membership registration for the member store (S51).

The customer device 50 may transfer information including, for example, basic customer information (e.g., ID, password, name, gender, address, interests, etc.), customer identification information, and access configuration information.

The customer identification information is information for customer identification in the blockchain network 300, and may correspond to, for example, an electronic wallet address and an authentication key (public key/private key) which are given to a customer in order to identify the customer in the blockchain network 300.

The access configuration information is information for restricting access to customer data in the blockchain network 300 on the basis of an intention of a customer according to the second embodiment of the present disclosure, and may be configured including, for example, whether information collection is allowed for each information collection medium, and a type of customer data, from which information can be collected by a specific information collection medium.

The type of customer data may be classified as respective pieces of service identification information according to a type of a service (purchase, search, sale, etc.) used by a customer in the member store device 60.

Accordingly, for the access configuration information, whether information collection is allowed for a specific information collection medium, and one or more types of customer data, from which information can be collected, when information collection is allowed may be configured as service identification information reflecting the intention of the customer.

Then, the member store device 60 generates a smart contract for a customer by reflection of the information received from the customer device 50 according to the membership subscription procedure (S52-S53).

Here, the member store device 60 may reflect the access configuration information, may generate a smart contract including, for example, an information collection condition, an information permission policy, and an information reward policy, and may store the same as a transaction block matching customer identification information in the blockchain network 300.

Then, when a service is used in the customer device 50 after membership registration, the member store device 60 matches customer data (e.g., log information) based on the service use with customer identification information received from the customer device 50, so as to store the matched data and information as a transaction block in the blockchain network 300 (S54-S56).

When two or more services are used in the customer device 50, the member store device 60 may generate an individual transaction block matching each piece of service identification information, or may integratedly generate a single transaction block irrelevant to the service identification information, so as to store the generated transaction block in the blockchain network 300.

Further, the member store device 60 determines whether information collection is possible, when an information collection request for a customer is received from an information collection medium (S57-S59).

That is, the member store device 60 checks the information collection condition from the smart contract distributed to the blockchain network 20, and determines whether the information collection medium having requested information collection satisfies the information collection condition.

The determination unit 63 may determine that information collection by the information collection medium is allowed according to the information collection condition, and when it is confirmed that a certain amount of electronic money has been paid for information collection, information collection by the information collection medium is possible.

Subsequently, when it is determined that information collection is possible for the information collection medium, the member store device 60 causes customer data stored in the blockchain network 300 to be transferred to the information collection medium (S60-S62).

That is, the member store device 60 checks the information permission policy from the smart contract distributed in the blockchain network 20, and causes at least a part of the entire specific customer, which is stored as a transaction block in the blockchain network 300, to be transferred to the information collection medium.

When the customer data is stored as an individual transaction block matching each piece of service identification information, the member store device 60 may check specific service identification information, from which information collection is permitted, according to the information permission policy, and may acquire and transfer the customer data from a transaction block matching the specific service identification information from among transaction blocks stored in the blockchain network 300.

When the customer data is integrated and stored as a single transaction block irrelevant to the service identification information, an information transfer filter is applied to transfer the customer data.

That is, the member store device 60 generates an information transfer filter to transfer the customer data of the specific service identification information, from which information collection is permitted, according to the information permission policy, and applies the information transfer filter to the entire customer data acquired from the transaction blocks of the blockchain network 300, so as to cause only the customer data of the specific service identification information to be transferred to the information collection medium.

Here, it may be understood that the information transfer filter is information for encrypting customer data of the remaining service identification information, excluding the customer data corresponding to the specific service identification information from among the entire customer data acquired from the transaction blocks of the blockchain network 300.

Thereafter, when the customer data has been transferred to the information collection medium, the member store device 60 transfers, as a reward, a certain amount of electronic money to the customer device 50 accordingly (S63-S64).

That is, the member store device 60 checks the information reward policy from the smart contract distributed to the blockchain network 20, and transfers the electronic money issued from the blockchain network 300 to the customer device 50, as the reward for information collection according to the information reward policy.

Here, the electronic money provided as the reward may be, for example, electronic money issued in response to a request of the member store device 60, or may be a part of the amount of electronic money paid for information collection by the information collection medium according to the information reward policy in the smart contract.

The description of the operation flow in the member store service system according to the second embodiment of the present disclosure has been finished, and the description of the operation flow in the customer device 50 will be continued.

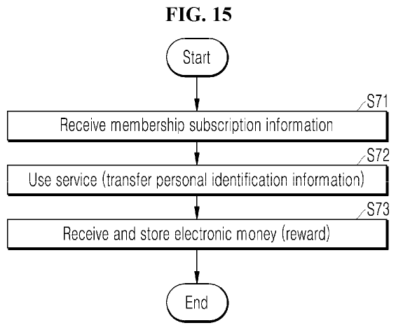

FIG. 15 shows an operation flow in the customer device 50 according to the second embodiment of the present disclosure.

First, the registration unit 51 transfers, to the member store device 60, information that is input from a customer according to a membership subscription procedure required from the member store device 60, so as to process membership registration for the member store (S71).

The registration unit 51 may transfer, for example, basic customer information (e.g., ID, password, name, gender, address, interests, etc.), customer identification information, and access configuration information.

The customer identification information is information for customer identification in the blockchain network 300, and may correspond to, for example, an electronic wallet address and an authentication key (public key/private key) which are given to a customer in order to identify the customer in the blockchain network 300.

The access configuration information is information for restricting access to customer data in the blockchain network 300 on the basis of an intention of a customer according to the second embodiment of the present disclosure, and may be configured including, for example, whether information collection is allowed for each information collection medium, and a type of customer data, from which information can be collected by a specific information collection medium.

Here, the type of customer data may be classified as respective pieces of service identification information according to a type of a service (purchase, search, sale, etc.) used by a customer in the member store device 60.

Accordingly, for the access configuration information, whether information collection is allowed for a specific information collection medium, and one or more types of customer data, from which information can be collected, when information collection is allowed may be configured as service identification information reflecting the intention of the customer.

The access configuration information is generated by being included in a smart contract for each customer, which defines a series of procedures according to an information collection request received from an information collection medium, and is distributed to the blockchain network 300, so as to be stored as one transaction block.

The smart contract is stored as a transaction block matching customer identification information, and may be generated including, for example, an information collection condition, an information permission policy, and an information reward policy.

Here, it may be understood that the information collection condition is information on whether information collection is allowed for a specific information collection medium and information on the amount of electronic money required to be paid for information collection, the information permission policy is information on the type of customer data which can be collected by a specific information collection medium permitted for information collection, and the information reward policy is information for transferring of rewards for information collection to the customer.

Further, when a service provided by a member store is used after membership registration, the utilization unit 52 transfers personal identification information of a customer to the member store device 60, thereby enabling the member store device 60, which has received the personal identification information, to match the personal identification information with customer data (e.g., log information) based on service use, so as to store the matched data and information as a transaction block in the blockchain network 300 (S72).

As described above, the customer data may be classified as two or more pieces of service identification information according to the type of the service provided by the member store, and when a specific customer uses two or more services, an individual transaction block matching each piece of the service identification information may be generated, or a single transaction block irrelevant to the service identification information may be integratedly generated and stored in the blockchain network 300.

Thereafter, when the customer data is collected by the information collection medium, the transaction unit 53 receives, from the member store device 60, electronic money configured to be a reward for collection of the customer data (S73).

In this regard, when the information collection medium has collected the customer data, the member store device 60 transfers electronic money issued from the blockchain network 300 to an electronic wallet address of the customer device 50 according to the information reward policy in the smart contract.

Here, the electronic money provided as rewards may be, for example, electronic money issued in response to a request of the member store device 60, or may be a part of the amount of electronic money paid for information collection by the information collection medium according to the information reward policy in the smart contract.

The description of the operation flow in the customer device 50 according to the second embodiment of the present disclosure has been finished, and the description of the operation flow in the member store device 60 will be continued.

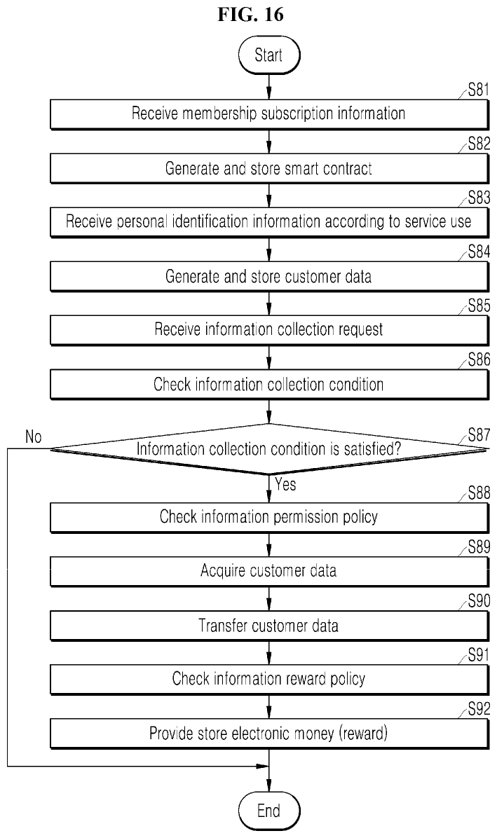

FIG. 16 shows an operation flow in the member store device 60 according to the second embodiment of the present disclosure.

First, the generation unit 61 generates a smart contract for a customer by reflection of information received from the customer device 50 according to a membership subscription procedure (S81-S82).

The information received from the customer device 50 may include, for example, basic customer information (e.g., ID, password, name, gender, address, interests, etc.), customer identification information, and access configuration information.

The customer identification information is information for customer identification in the blockchain network 300, and may correspond to, for example, an electronic wallet address and an authentication key (public key/private key) which are given to a customer in order to identify the customer in the blockchain network 300.

The access configuration information is information for restricting access to customer data in the blockchain network 300 on the basis of an intention of a customer according to the second embodiment of the present disclosure, and may be configured including, for example, whether information collection is allowed for each information collection medium, and a type of customer data, from which information can be collected by a specific information collection medium.

Here, the type of customer data may be classified as respective pieces of service identification information according to a type of a service (purchase, search, sale, etc.) used by a customer in the member store device 60.

Accordingly, for the access configuration information, whether information collection is allowed for a specific information collection medium, and one or more types of customer data, from which information can be collected, when information collection is allowed may be configured as service identification information reflecting the intention of the customer.

The generation unit 61 may reflect the access configuration information, may generate a smart contract including, for example, an information collection condition, an information permission policy, and an information reward policy, and may store the same as a transaction block matching customer identification information in the blockchain network 300.

Then, when a service is used in the customer device 50 after membership registration, the storage unit 62 matches customer data (e.g., log information) based on the service use with customer identification information received from the customer device 50, so as to store the matched data and information as a transaction block in the blockchain network 300 (S83-S84).

As described above, the customer data is classified as two or more pieces of service identification information according to a type of the service provided by the member store.

Therefore, when two or more services are used in the customer device 50, the storage unit 62 may generate an individual transaction block matching each piece of service identification information, or may integratedly generate a single transaction block irrelevant to the service identification information, so as to store the generated transaction block in the blockchain network 300.

Then, when an information collection request for the customer is received from an information collection medium, the determination unit 63 determines whether information collection is possible (S85-S87).

That is, the determination unit 63 checks the information collection condition from the smart contract distributed to the blockchain network 20, and determines whether the information collection medium having requested information collection satisfies the information collection condition.

The determination unit 63 may determine that information collection by the information collection medium is allowed according to the information collection condition, and when it is confirmed that a certain amount of electronic money has been paid for information collection, information collection by the information collection medium is possible.

Further, when it is determined that information collection is possible for the information collection medium, the transfer unit 64 causes the customer data stored in the blockchain network 300 to be transferred to the information collection medium (S48-S50).

That is, the transfer unit 64 checks the information permission policy from the smart contract distributed in the blockchain network 20, and causes at least a part of the entire specific customer, which is stored as a transaction block in the blockchain network 300, to be transferred to the information collection medium.

When the customer data is stored as an individual transaction block matching each piece of service identification information, the transfer unit 64 may check specific service identification information, from which information collection is permitted, according to the information permission policy, and may acquire and transfer the customer data from a transaction block matching the specific service identification information from among transaction blocks stored in the blockchain network 300.

When the customer data is integrated and stored as a single transaction block irrelevant to the service identification information, an information transfer filter is applied to transfer the customer data.

That is, the transfer unit 64 generates an information transfer filter to transfer customer data of specific service identification information, from which information collection is permitted, according to the information permission policy, and applies the information transfer filter to the entire customer data acquired from the transaction blocks of the blockchain network 300, so as to cause only the customer data of the specific service identification information to be transferred to the information collection medium.

Here, it may be understood that the information transfer filter is information for encrypting customer data of the remaining service identification information, excluding the customer data corresponding to the specific service identification information from among the entire customer data acquired from the transaction blocks of the blockchain network 300.

Thereafter, when the customer data has been transferred to the information collection medium, the reward unit 65 transfers, as a reward, a certain amount of electronic money to the customer device 50 accordingly (S91-S92).

That is, the reward unit 65 checks the information reward policy from the smart contract distributed to the blockchain network 20, and transfers the electronic money issued from the blockchain network 300 to the customer device 50, as the reward for information collection according to the information reward policy.

Here, the electronic money provided as the reward may be, for example, electronic money issued in response to a request of the member store device 60, or may be a part of the amount of electronic money paid for information collection by the information collection medium according to the information reward policy in the smart contract.

As described above, according to the operation method of respective elements within the member store service system according to the second embodiment of the present disclosure, it may be seen that customer data related to use of a service of a member store is stored in a blockchain network, and collection (viewing) of the customer data stored in the blockchain network may be restricted according to customer settings, so that stable use of the customer data is possible on the basis of the stability and reliability of the blockchain technology and an intention of a customer.

The implementations of the functional operations and subject matter described in the present disclosure may be realized by a digital electronic circuit, by the structure described in the present disclosure, and the equivalent including computer software, firmware, or hardware including, or by a combination of one or more thereof. Implementations of the subject matter described in the specification may be implemented in one or more computer program products, that is, one or more modules related to a computer program command encoded on a tangible program storage medium to control an operation of a processing system or the execution by the operation.

A computer-readable medium may be a machine-readable storage device, a machine-readable storage substrate, a memory device, a composition of materials influencing a machine-readable radio wave signal, or a combination of one or more thereof.

In the specification, the term “system” or “device”, for example, covers a programmable processor, a computer, or all kinds of mechanisms, devices, and machines for data processing, including a multiprocessor and a computer. The processing system may include, in addition to hardware, a code that creates an execution environment for a computer program when requested, such as a code that constitutes processor firmware, a protocol stack, a database management system, an operating system, or a combination of one or more thereof.

A computer program (also known as a program, software, software application, script, or code) can be written in any form of programming language, including compiled or interpreted languages, declarative or procedural languages, and it can be deployed in any form, including as a stand-alone program or module, a component, subroutine, or another unit suitable for use in a computer environment. A computer program may, but need not, correspond to a file in a file system. A program can be stored in a single file provided to the requested program, in multiple coordinated files (for example, files that store one or more modules, sub-programs, or portions of code), or in a portion of a file that holds other programs or data (for example, one or more scripts stored in a markup language document). A computer program can be deployed to be executed on one computer or on multiple computers that are located at one site or distributed across a plurality of sites and interconnected by a communication network.

A computer-readable medium suitable for storing a computer program command and data includes all types of non-volatile memories, media, and memory devices, for example, a semiconductor memory device such as an EPROM, an EEPROM, and a flash memory device, and a magnetic disk such as an external hard disk or an external disk, a magneto-optical disk, a CD-ROM, and a DVD-ROM disk. A processor and a memory may be added by a special purpose logic circuit or integrated into the logic circuit.

The implementations of the subject matter described in the specification may be implemented in a calculation system including a back-end component such as a data server, a middleware component such as an application server, a front-end component such as a client computer having a web browser or a graphic user interface which can interact with the implementations of the subject matter described in the specification by the user, or all combinations of one or more of the back-end, middleware, and front-end components. The components of the system can be mutually connected by any type of digital data communication such as a communication network or a medium.

While the specification contains many specific implementation details, these should not be construed as limitations to the scope of any disclosure or of what may be claimed, but rather as descriptions of features that may be specific to particular embodiments of particular disclosures. Certain features that are described in the specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

In addition, in the specification, the operations are illustrated in a specific sequence in the drawings, but it should be understood that the operations are not necessarily performed in the shown specific sequence or that all shown operations are necessarily performed in order to obtain a preferable result. In a specific case, multitasking and parallel processing may be preferable. Furthermore, it should not be understood that a separation of the various system components of the above-mentioned implementation is required in all implementations. In addition, it should be understood that the described program components and systems usually may be integrated in a single software package or may be packaged in a multi-software product.

As described above, specific terms disclosed in the specification do not intend to limit the present disclosure. Therefore, while the present disclosure was described in detail with reference to the above-mentioned examples, a person skilled in the art may modify, change, and transform some parts without departing a scope of the present disclosure. The scope of the present disclosure is defined by the appended claims to be described later, rather than the detailed description. Accordingly, it will be appreciated that all modifications or variations derived from the meaning and scope of the appended claims and their equivalents are included in the range of the present disclosure.

What is claimed is:

1. An electronic commerce service device comprising:
a processor configured to process operations related to a blockchain network; and
a memory configured to store at least one command executed via the processor,
wherein the at least one command comprises:
a bid command for selection of a supplier of a specific product via competitive bidding for a supply price in response to a purchase request for the specific product received from a purchaser; and
a generation command for causing generation of a transaction related to the competitive budding so as to cause a bid information blockchain to be generated in the blockchain network.

2. The device of claim 1, wherein the at least one command further comprises a delivery command for approving of a delivery request made by a distributor identifying delivery information from the bid information blockchain, and tracking of a delivery state of the specific product.

3. The device of claim 2, wherein the generation command causes generation of a transaction related to delivery of the specific product so as to cause generation of a service completion blockchain in which a transaction block is added to the bid information blockchain.

4. The device of claim 2, wherein, in the service completion blockchain, evaluation information generated by evaluation of a purchaser with respect to at least one of the supplier and the distributor is recorded as a transaction block; and
the evaluation information is used as information for restricting competitive bidding participation for the supplier or restricting the delivery request for the distributor.

5. The device of claim 1, wherein the bid command causes a supply price, which is proposed by a bidder with respect to each product, to be pre-registered and updated as bid application information; and
when a purchase request for the specific product is made, the bid command causes competitive bidding to be conducted by selection of bid application information matching the specific product.

6. The device of claim 5, wherein, when the remaining time until an end of the competitive bidding is less than a threshold time, and a number of bidders participating in the competitive bidding is less than the threshold number, the bid command causes competitive bidding for the remaining time to be conducted by selection of the pre-registered bid application information.

7. The device of claim 2, wherein, when a delivery request area is designated on the basis of a location of at least one of the purchaser and the supplier, the delivery information is recorded, in the bid information blockchain, as a transaction block matching electronic wallet address information of the distributor setting the delivery request area as a delivery available area; and
when there are multiple bid information blockchains generated in the blockchain network, the distributor collectively identifies delivery information matching the electronic wallet address information from the multiple bid information blockchains.

8. The device of claim 2, wherein the at least one command further comprises a generation command for generation of a smart contract for distribution to the blockchain network, so as to cause at least one of the competitive bidding and delivery of the specific product to be processed according to the smart contract.

9. An operation method of an electronic commerce service device, the method comprising:
a bidding operation of selecting a supplier of a specific product via competitive bidding for a supply price in response to a purchase request for the specific product received from a purchaser; and
a generation operation of causing generation of a transaction related to the competitive budding so as to cause a bid information blockchain to be generated in the blockchain network.

10. The method of claim 9, further comprising: a delivery operation of approving a delivery request made by a distributor identifying delivery information from the bid information blockchain, and tracking a delivery state of the specific product.

11. The method of claim 10, further comprising: a generation operation of, when delivery of the specific product is processed, causing generation of a transaction related to the delivery of the specific product, so as to cause generation of a service completion blockchain in which a transaction block is added to the bid information blockchain.

12. The method of claim 10, wherein, in the service completion blockchain, evaluation information generated by evaluation of a purchaser with respect to at least one of the supplier and the distributor is recorded as a transaction block; and
the evaluation information is used as information for restricting competitive bidding participation for the supplier or restricting the delivery request for the distributor.

13. A service device comprising:
a processor configured to process operations related to a blockchain network; and
a memory configured to store at least one command executed via the processor,
wherein the at least one command comprises:
a determination command for determining of whether an information collection medium satisfies an information collection condition in response to a request for collecting information on a specific customer, which is received from the information collection medium; and
a transfer command for, when the information collection condition is satisfied, causing transferring of at least a part of the entire customer data of the specific customer, which is stored as a transaction block in the blockchain network, to the information collection medium according to an information permission policy.

14. The device of claim 13, wherein the at least one command further comprises a reward command for, when the customer data is transferred to the information collection medium, causing electronic money issued in the blockchain network to be transferred to the specific customer according to an information reward policy.

15. The device of claim 14, wherein at least one of the information collection condition, the information permission policy, and the information reward policy is generated as a smart contract for the specific customer so as to be stored in the blockchain network; and
the smart contract is generated on the basis of access configuration information input from the specific customer according to a membership subscription procedure of a member store.

16. The device of claim 13, wherein the customer data is classified by two or more pieces of service identification information according to a type of a service provided by a member store; and
when the specific customer uses two or more services, the customer data is generated as an individual transaction block matching each piece of service identification information, or is integrated into a single transaction block so as to be stored in the blockchain network.

17. The device of claim 16, wherein, when the customer data is generated as an individual transaction block matching each piece of service identification information, the transfer command causes identification of specific service identification information, for which information collection is permitted, according to the information permission policy, and causes customer data to be acquired from a transaction block matching the specific service identification information from transaction blocks stored in the blockchain network.

18. The device of claim 16, wherein, when the customer data is integrated into a single transaction block irrelevant to service identification information, the transfer command causes generation of an information transfer filter to transfer customer data of specific service identification information, for which information collection is permitted, according to the information permission policy; and
the transfer command causes only the customer data of the specific service identification information to be transferred to the information collection medium by applying the information transfer filter to the entire customer data acquired from the transaction block of the blockchain network.

19. The device of claim 18, wherein the information transfer filter is for encrypting customer data of service identification information remaining after excluding the customer data corresponding to the specific service identification information from the entire customer data acquired from the transaction block of the blockchain network.

20. The device of claim 14, wherein electronic money to be transferred to the specific customer is at least a part of the amount of electronic money that the information collection medium pays for information collection according to the information collection condition.
